(19) United States
(12) Patent Application Publication
(10) Pub. No.: US 2009/0144243 A1
(43) Pub. Date: Jun. 4, 2009

(54) User interface for searching research data

(75) Inventor: Christopher G. Modzelewski, Boonton, NJ (US)

Correspondence Address: Nixon Peabody LLP, 200 Page Mill Road, Palo Alto, CA, 94306, US

(73) Assignee: ChartSource, Inc., a Delaware Corporation

(21) Appl. No.: 11/999,186

(22) Filed: Dec. 3, 2007

(51) Int. Cl. G06F 17/30; G06F 17/00; G06F 7/00; G06Q 30/00

(52) U.S. Cl. 707/3; 707/102; 707/6; 705/27; 705/30; 707/E17.001; 707/E17.014; 707/E17.017

(57) ABSTRACT

Rendering a research data-related information includes presenting a research data supplier interface for a research data supplier interested in providing research data to be searched by a research data user interested in searching research data, and presenting a research data user interface for the research data user.

### RELATED APPLICATIONS

This application may be related to one or more of the following commonly assigned United States Patent Applications filed on even date herewith:

Ser. No. ______, entitled “System for Searching Research Data” (Attorney Docket No. CHART-0001 (038284-006);

Ser. No. ______, entitled “Data Search Markup Language for Searching Research Data” (Attorney Docket No. CHART-0002 (038284-007);

Ser. No. ______, entitled “Indexer for Searching Research Data” (Attorney Docket No. CHART-0003 (038284-008);

Ser. No. ______, entitled “Search Term Parser for Searching Research Data” (Attorney Docket No. CHART-0004 (038284-009);

Ser. No. ______, entitled “Search Engine for Searching Research Data” (Attorney Docket No. CHART-0005 (038284-010); and

Ser. No. ______, entitled “Chart Generator for Searching Research Data” (Attorney Docket No. CHART-0006 (038284-011).

The related applications are hereby incorporated herein by reference as if set forth fully herein.

### FIELD OF THE INVENTION

The present invention relates to the field of computer science. More particularly, the present invention relates to searching research data.

### BACKGROUND OF THE INVENTION

Traditional search engines such as Yahoo™ or Google™ provide text-based search results that are often marginally useful because irrelevant information is often included in the search results, and because relevant information must be pieced together manually from multiple sources and then formatted to create useful search results. This process is cumbersome and error-prone.

Additionally, traditional search engines are typically limited to searching information in the public domain, such as public Web sites, press releases, free reports, and free presentations. However, most data is not in the public domain, so typical search engines cannot access the data. Accordingly, a need exists for an improved solution for searching research data.

### SUMMARY OF THE INVENTION

Rendering a research data-related information includes presenting a research data supplier interface for a research data supplier interested in providing research data to be searched by a research data user interested in searching research data, and presenting a research data user interface for the research data user.

### BRIEF DESCRIPTION OF THE DRAWINGS

The accompanying drawings, which are incorporated into and constitute a part of this specification, illustrate one or more embodiments of the present invention and, together with the detailed description, serve to explain the principles and implementations of the invention.

In the drawings:

FIG. 1 is a block diagram of a computer system suitable for implementing aspects of the present invention.

FIG. 2 is a block diagram that illustrates a system for searching research data in accordance with one embodiment of the present invention.

FIG. 3 is a flow diagram that illustrates a method for searching research data in accordance with one embodiment of the present invention.

FIG. 4 is a flow diagram that illustrates a method searching research data from the perspective of a data supplier in accordance with one embodiment of the present invention.

FIG. 5 is a flow diagram that illustrates a method searching research data from the perspective of a search engine in accordance with one embodiment of the present invention.

FIG. 6 is a flow diagram that illustrates a method searching research data from the perspective of a user in accordance with one embodiment of the present invention.

FIG. 7 is a flow diagram that illustrates a method for parsing research data in accordance with one embodiment of the present invention.

FIG. 8 is a flow diagram that illustrates a method for defining and using a data search markup language in accordance with one embodiment of the present invention.

FIG. 9 is a flow diagram that illustrates indexing research data in accordance with one embodiment of the present invention.

FIG. 10 is a block diagram that illustrates consistency checking in accordance with one embodiment of the present invention.

FIG. 11 is a flow diagram that illustrates searching research data in accordance with one embodiment of the present invention.

FIG. 12 is a block diagram that illustrates research-related parameters in accordance with one embodiment of the present invention.

FIG. 13 is a flow diagram that illustrates a method for parsing a search term in accordance with one embodiment of the present invention.

FIG. 14A is a block diagram that illustrates a tokenized search term in accordance with one embodiment of the present invention.

FIG. 14B is a block diagram that illustrates example initial phrases based on the tokenized search term of FIG. 14A.

FIG. 15 is a block diagram that illustrates a phrase-meaning table in accordance with one embodiment of the present invention.

FIG. 16 is a block diagram that illustrates example interpretations for the phrase-meaning table of FIG. 15.

FIG. 17A is a table that illustrates example keywords associated with a “frequency distribution” function in accordance with one embodiment of the present invention.

FIG. 17B is a table that illustrates example keywords associated with a “cross-tab” function in accordance with one embodiment of the present invention.

FIG. 17C is a table that illustrates example keywords associated with a “juxtapose” function in accordance with one embodiment of the present invention.

FIG. 17D is a table that illustrates example keywords associated with a “break” function in accordance with one embodiment of the present invention.

FIG. 17E is a table that illustrates example keywords associated with a “comparison” function in accordance with one embodiment of the present invention.

FIG. 17F is a table that illustrates example keywords associated with a “growth” function in accordance with one embodiment of the present invention.

FIG. 17G is a table that illustrates example keywords associated with a “CiGR” function in accordance with one embodiment of the present invention.

FIG. 17H is a table that illustrates example keywords associated with a “sum” function in accordance with one embodiment of the present invention.

FIG. 17I is a table that illustrates example keywords associated with a “average” function in accordance with one embodiment of the present invention.

FIG. 17J is a table that illustrates example keywords associated with a “divide” function in accordance with one embodiment of the present invention.

FIG. 19 is a flow diagram that illustrates a method for searching research data in accordance with one embodiment of the present invention.

FIG. 20 is a block diagram that illustrates instructions for data execution in accordance with one embodiment of the present invention.

FIG. 21 is a flow diagram that illustrates generating a chart for rendering research data search results in accordance with one embodiment of the present invention.

FIG. 22 is a flow diagram that illustrates determining a chart type for a “Growth,” “CiGR,” or “CGR” function in accordance with one embodiment of the present invention.

FIG. 23A is a block diagram that illustrates chart characteristics in accordance with one embodiment of the present invention.

FIG. 23B is a block diagram that illustrates chart types in accordance with one embodiment of the present invention.

FIG. 24 is a flow diagram that illustrates a method for setting maximum and minimum values for a scale in accordance with one embodiment of the present invention.

FIG. 25 is a flow diagram that illustrates a method for creating a report based on search results in accordance with one embodiment of the present invention.

FIG. 26 is a flow diagram that illustrates a method for data cleanup in accordance with one embodiment of the present invention.

FIG. 27 is a flow diagram that illustrates a method for removing duplicate data in accordance with one embodiment of the present invention.

FIG. 28 is a flow diagram that illustrates a method for data visualization in accordance with one embodiment of the present invention.

FIG. 29 is a flow diagram that illustrates a method for determining y-axis and axis scale in accordance with one embodiment of the present invention.

FIG. 30 is a flow diagram that illustrates a method for function identification in accordance with one embodiment of the present invention.

FIG. 31 is a flow diagram that illustrates a method for merged sub-chart rendering in accordance with one embodiment of the present invention.

FIG. 32 is a flow diagram that illustrates a method for handling a “cross-tab” function in accordance with one embodiment of the present invention.

FIG. 33 is a flow diagram that illustrates a method for handling a “juxtapose” function in accordance with one embodiment of the present invention.

FIG. 34 is a flow diagram that illustrates a method for handling a comparison function in accordance with one embodiment of the present invention.

FIG. 35 is a flow diagram that illustrates a method for rendering research data search results in accordance with one embodiment of the present invention.

FIG. 36 illustrates an example line chart.

FIG. 37 illustrates an example bar chart.

FIG. 38 illustrates and example two-dimensional column chart.

FIG. 39 illustrates an example three-dimensional column chart.

FIG. 40 illustrates an example pie chart.

FIG. 41 illustrates an example stacked bar chart.

FIG. 42 illustrates and example stacked column chart.

FIG. 43 illustrates an example scatter chart.

### DETAILED DESCRIPTION

Embodiments of the present invention are described herein in the context of searching research data. Those of ordinary skill in the art will realize that the following detailed description of the present invention is illustrative only and is not intended to be in any way limiting. Other embodiments of the present invention will readily suggest themselves to such skilled persons having the benefit of this disclosure. Reference will now be made in detail to implementations of the present invention as illustrated in the accompanying drawings. The same reference indicators will be used throughout the drawings and the following detailed description to refer to the same or like parts.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

According to one embodiment of the present invention, the components, process steps, and/or data structures may be implemented using various types of operating systems (OS), computing platforms, firmware, computer programs, computer languages, and/or general-purpose machines. The method can be run as a programmed process running on processing circuitry. The processing circuitry can take the form of numerous combinations of processors and operating systems, connections and networks, data stores, or a stand-alone device. The process can be implemented as instructions executed by such hardware, hardware alone, or any combination thereof. The software may be stored on a program storage device readable by a machine.

According to one embodiment of the present invention, the components, processes and/or data structures may be implemented using machine language, assembler, C or C++, Java and/or other high level language programs running on a data processing computer such as a personal computer, workstation computer, mainframe computer, or high performance server running an OS such as Solaris® available from Sun Microsystems, Inc. of Santa Clara, Calif., Windows Vista™, Windows NT®, Windows XP, Windows XP PRO, and Windows® 2000, available from Microsoft Corporation of Redmond, Wash., Apple OS X-based systems, available from Apple Inc. of Cupertino, Calif., or various versions of the Unix operating system such as Linux available from a number of vendors. The method may also be implemented on a multiple-processor system, or in a computing environment including various peripherals such as input devices, output devices, displays, pointing devices, memories, storage devices, media interfaces for transferring data to and from the processor(s), and the like. In addition, such a computer system or computing environment may be networked locally, or over the Internet or other networks. Different implementations may be used and may include other types of operating systems, computing platforms, computer programs, firmware, computer languages and/or general-purpose machines; and. In addition, those of ordinary skill in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein.

In the context of the present invention, the term “network” includes local area networks (LANs), wide area networks (WANs), metro area networks, residential networks, corporate networks, inter-networks, the Internet, the World Wide Web, cable television systems, telephone systems, wireless telecommunications systems, fiber optic networks, token ring networks, Ethernet networks, ATM networks, frame relay networks, satellite communications systems, and the like. Such networks are well known in the art and consequently are not further described here.

In the context of the present invention, the term “identifier” describes an ordered series of one or more numbers, characters, symbols, or the like. More generally, an “identifier” describes any entity that can be represented by one or more bits.

In the context of the present invention, the term “processor” describes a physical computer (either stand-alone or distributed) or a virtual machine (either stand-alone or distributed) that processes or transforms data. The processor may be implemented in hardware, software, firmware, or a combination thereof.

In the context of the present invention, the term “data stores” describes a hardware and/or software means or apparatus, either local or distributed, for storing digital or analog information or data. The term “Data store” describes, by way of example, any such devices as random access memory (RAM), read-only memory (ROM), dynamic random access memory (DRAM), static dynamic random access memory (SDRAM), Flash memory, hard drives, disk drives, floppy drives, tape drives, CD drives, DVD drives, magnetic tape devices (audio, visual, analog, digital, or a combination thereof), optical storage devices, electrically erasable programmable read-only memory (EEPROM), solid state memory devices and Universal Serial Bus (USB) storage devices, and the like. The term “Data store” also describes, by way of example, databases, file systems, record systems, object oriented databases, relational databases, SQL databases, audit trails and logs, program memory, cache and buffers, and the like.

In the context of the present invention, the term “network interface” describes the means by which users access a network for the purposes of communicating across it or retrieving information from it.

In the context of the present invention, the term “user interface” describes any device or group of devices for presenting and/or receiving information and/or directions to and/or from persons. A user interface may comprise a means to present information to persons, such as a visual display projector or screen, a loudspeaker, a light or system of lights, a printer, a Braille device, a vibrating device, or the like. A user interface may also include a means to receive information or directions from persons, such as one or more or combinations of buttons, keys, levers, switches, knobs, touch pads, touch screens, microphones, speech detectors, motion detectors, cameras, and light detectors. Exemplary user interfaces comprise pagers, mobile phones, desktop computers, laptop computers, handheld and palm computers, personal digital assistants (PDAs), cathode-ray tubes (CRTs), keyboards, keypads, liquid crystal displays (LCDs), control panels, horns, sirens, alarms, printers, speakers, mouse devices, consoles, and speech recognition devices.

In the context of the present invention, the term “system” describes any computer information and/or control device, devices or network of devices, of hardware and/or software, comprising processor means, data storage means, program means, and/or user interface means, which is adapted to communicate with the embodiments of the present invention, via one or more data networks or connections, and is adapted for use in conjunction with the embodiments of the present invention.

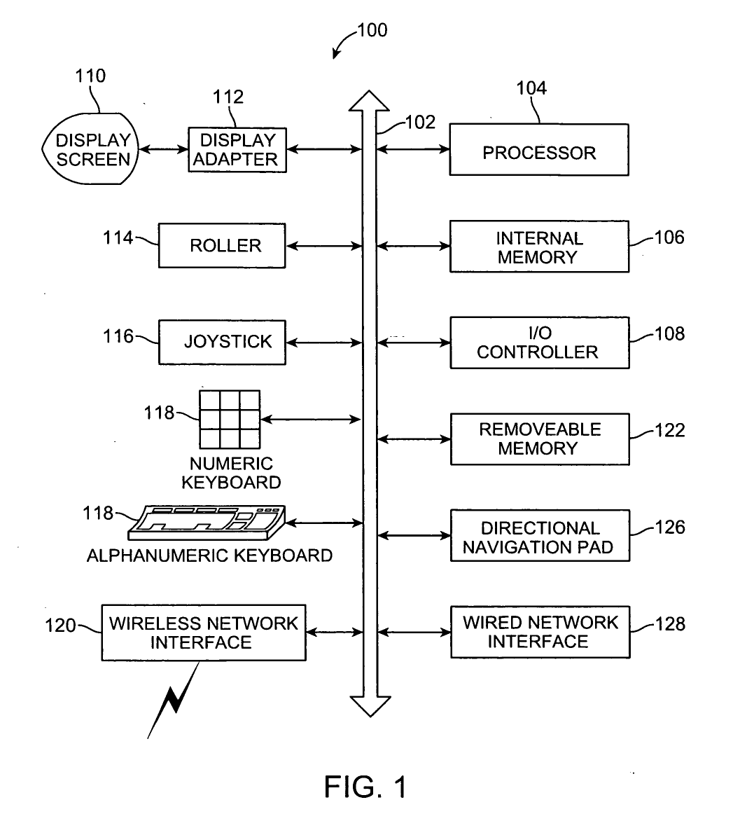

FIG. 1 depicts a block diagram of a computer system 100 suitable for implementing aspects of the present invention. As shown in FIG. 1, system 100 includes a bus 102 which interconnects major subsystems such as a processor 104, an internal memory 106 (such as a RAM), an input/output (I/O) controller 108, a removable memory (such as a memory card) 122, an external device such as a display screen 110 via display adapter 112, a roller-type input device 114, a joystick 116, a numeric keyboard 118, an alphanumeric keyboard 118, directional navigation pad 126 and a wireless interface 120. Many other devices can be connected. Wireless network interface 120, wired network interface 128, or both, may be used to interface to a local or wide area network (such as the Internet) using any network interface system known to those skilled in the art.

Many other devices or subsystems (not shown) may be connected in a similar manner. Also, it is not necessary for all of the devices shown in FIG. 1 to be present to practice the present invention. Furthermore, the devices and subsystems may be interconnected in different ways from that shown in FIG. 1. Code to implement the present invention may be operably disposed in internal memory 106 or stored on storage media such as removable memory 122, a floppy disk, a thumb drive, a CompactFlash® storage device, a DVD-R (“Digital Versatile Disc” or “Digital Video Disc” -Recordable), a DVD-ROM (“Digital Versatile Disc” or “Digital Video Disc” read-only memory), a CD-R (Compact Disc-Recordable), or a CD-ROM (Compact Disc read-only memory).

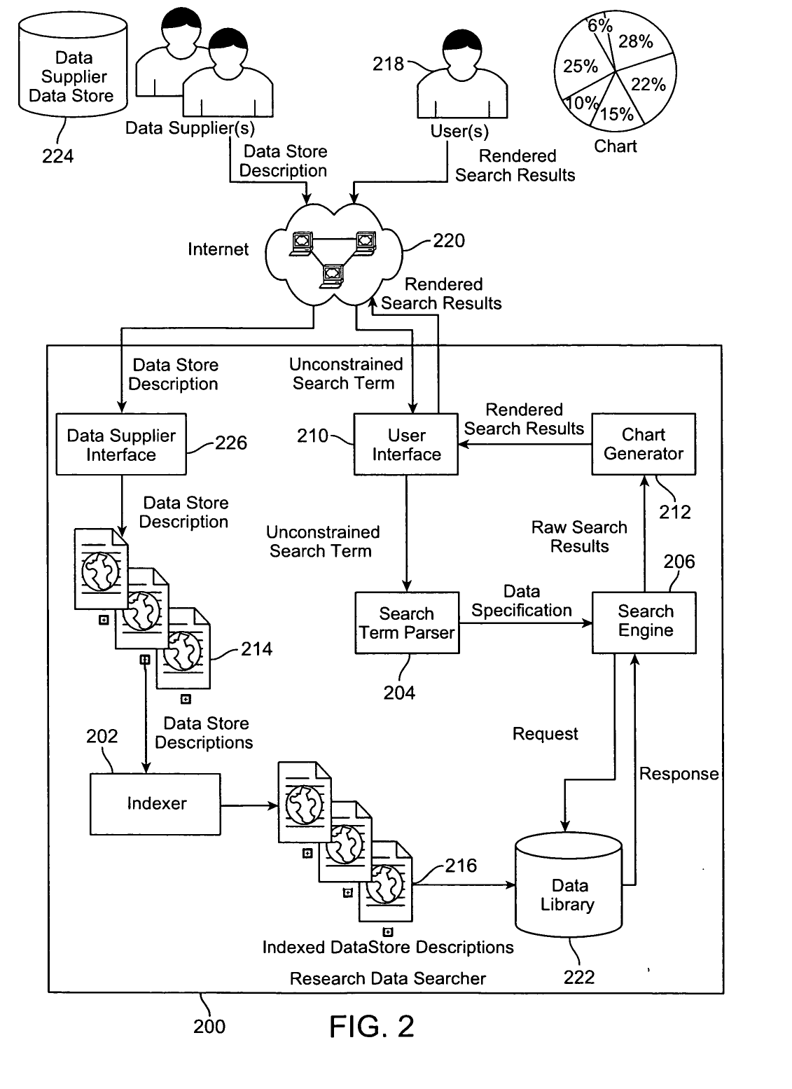

FIG. 2 is a block diagram that illustrates a system for searching research data in accordance with one embodiment of the present invention. As shown in FIG. 2, a system for searching research data comprises a data supplier interface 226, a user interface 210, an indexer 202, a data library 222, a search engine 206, a search term parser 204, and a chart generator 212. Data supplier interface 226 is coupled to indexer 202 and network 220 and is configured to receive one or more data store description 214 from one or more data supplier 224.

User interface 210 is coupled to search term parser 204, chart generator 212, and network 220, and is configured to receive one or more unconstrained search terms from user 218, send the one or more unconstrained search terms to search term parser 204, receive rendered search results from chart generator 212, and send the rendered search results to user 218 via network 220.

Indexer 202 is coupled to data supplier interface 226 and data library 222 and is configured to parse a file defined by a markup language that describes how to access a database, the structure of the database, the content of the database, and the content of individual columns of the database. Indexer 202 is further configured to translate the structure and one or more keyword descriptions of the content into a hierarchical vocabulary. A hierarchical vocabulary suitable for embodiments of the present invention is described further below. Indexer 202 is further configured to index the file index based upon successful completion of the parsing.

Data library 222 is coupled to indexer 220 and search engine 206 and is configured to store one or more indexed data store descriptions. Data library 222 may be any type of data store.

Search engine 206 is coupled to search term parser 204, data library 222, and chart generator 212, and is configured to receive one or more search parameters describing desired data, identify one or more columns of tables of one or more databases that comprise data relevant to the one or more search parameters, and dynamically construct instructions for extracting the data from one or more databases hosted on the one or more platforms.

Search term parser 204 is coupled to user interface 210 and search engine 206, and is configured to receive research data structured according to a markup language, translate the structure and one or more keyword descriptions of the content into a hierarchical vocabulary, and create one or more coded files containing the translation results.

Chart generator 212 is coupled to user interface 210 and search engine 206 and is configured to receive meta-data describing search results for desired research data residing in one or more databases hosted on one or more platforms, apply one or more rules to the meta-data to determine a report type, and extract the research data from the one or more databases. Chart generator 212 is further configured to create a report according to the report type for the research data.

In operation, data supplier interface 226 receives a file defined by a markup language that describes how to access a database, the structure of the database, the content of the database, and the content of individual columns of the database. Indexer 202 parses the file. Indexer 202 also translates the structure and one or more keyword descriptions of the content into a hierarchical vocabulary. Indexer 202 also indexes the file index based upon successful completion of the parsing. Indexer 202 also stores one or more indexed data store descriptions in data library 222.

User interface 210 receives one or more unconstrained search terms from user 218, sends the one or more unconstrained search terms to search term parser 204, receives rendered search results from chart generator 212, and sends the rendered search results to user 218 via network 220.

Search engine 206 receives one or more search parameters describing desired data, identifies one or more columns of tables of one or more databases that comprise data relevant to the one or more search parameters, and dynamically constructs instructions for extracting the data from one or more databases hosted on the one or more platforms.

Search term parser receives research data structured according to a markup language, translates the structure and one or more keyword descriptions of the content into a hierarchical vocabulary, and creates one or more coded files containing the translation results.

Chart generator 212 receives meta-data describing search results for desired research data residing in one or more databases hosted on one or more platforms, applies one or more rules to the meta-data to determine a report type, extracts the research data from the one or more databases, and creates a report according to the report type for the research data.

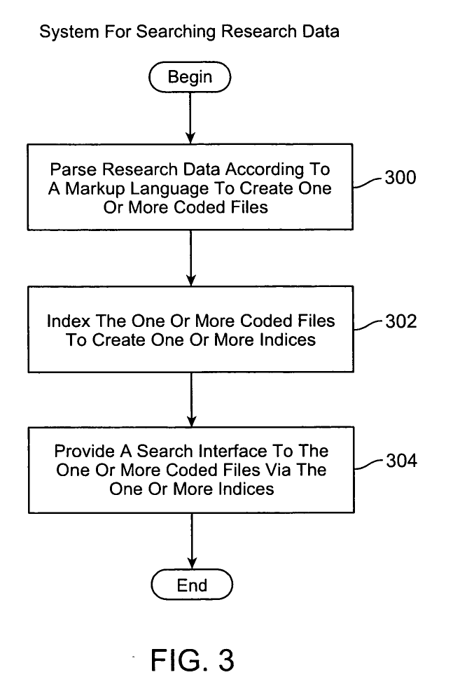

FIG. 3 is a flow diagram that illustrates a method for searching research data in accordance with one embodiment of the present invention. The processes illustrated in FIG. 3 may be implemented in hardware, software, firmware, or a combination thereof. At 300, research data is parsed according to a markup language to create one or more coded files. At 302, the one or more coded files are indexed to create one or more indices. At 304, a search interface is provided to the one or more coded files via the one or more indices.

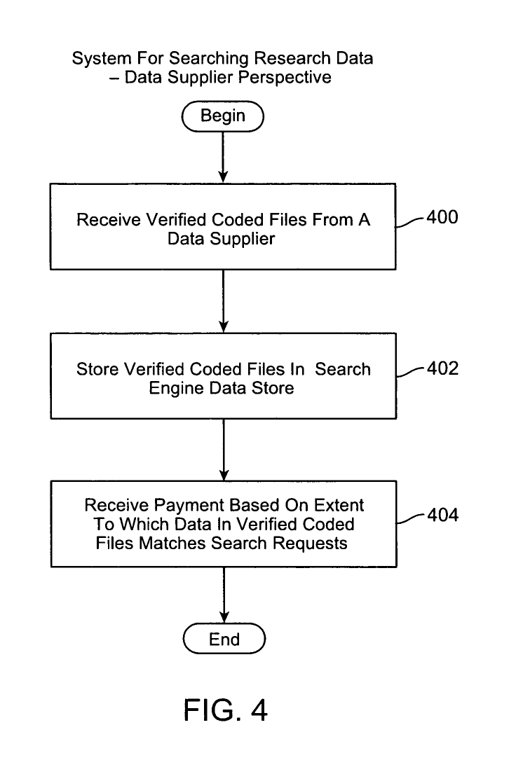

FIG. 4 is a flow diagram that illustrates a method searching research data from the perspective of a data supplier in accordance with one embodiment of the present invention. The processes illustrated in FIG. 4 may be implemented in hardware, software, firmware, or a combination thereof. At 400, verified coded files are received from a data supplier. At 402, the verified coded files are stored in a search engine data store. At 404, payment is received based on the extent to which data in the verified coded files matches search requests.

According to another embodiment of the present invention, the search engine retains a portion of the proceeds from the sale of a data supplier's data as a fixed percentage of the data supplier's sales through the platform.

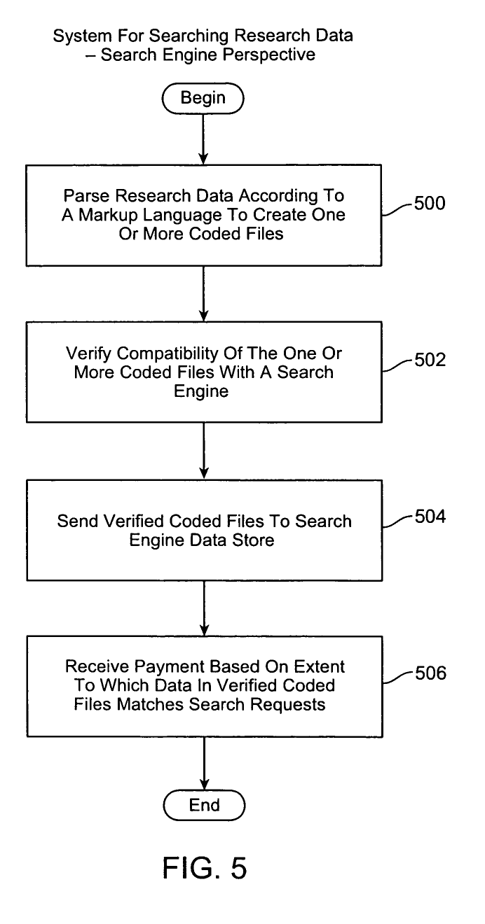

FIG. 5 is a flow diagram that illustrates a method searching research data from the perspective of a search engine in accordance with one embodiment of the present invention. The processes illustrated in FIG. 5 may be implemented in hardware, software, firmware, or a combination thereof. At 500, research data is parsed according to a markup language to create one or more coded files. At 502, compatibility of the one or more coded files with a search engine is verified. At 504, the verified coded files are sent to a search engine data store. At 506, payment is received based on the extent to which data in the verified coded files matches search requests.

According to one embodiment of the present invention, payment of a commission for sales of data through the search engine is apportioned between a data supplier and a search engine provider based at least in part on which entity hosts the data. According to another embodiment of the present invention, payment of a commission for sales of data through the search engine is apportioned between a data supplier and a search engine provider based at least in part on which entity codes the data.

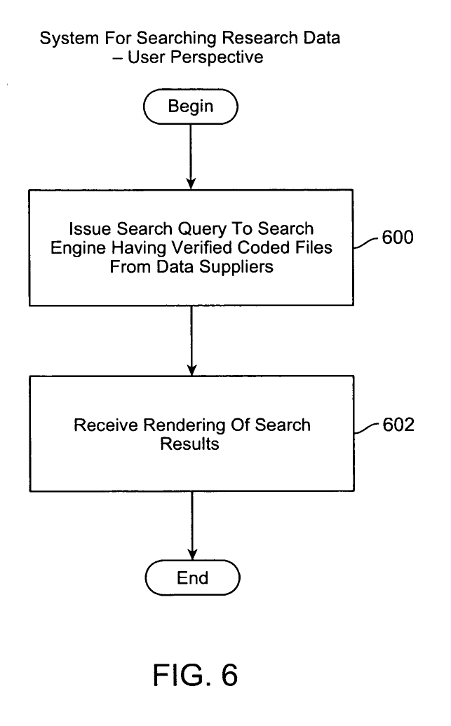

FIG. 6 is a flow diagram that illustrates a method searching research data from the perspective of a user in accordance with one embodiment of the present invention. The processes illustrated in FIG. 6 may be implemented in hardware, software, firmware, or a combination thereof. At 600, a search query is issued to a search engine having verified coded files from data suppliers. At 602, a rendering of the search results is received.

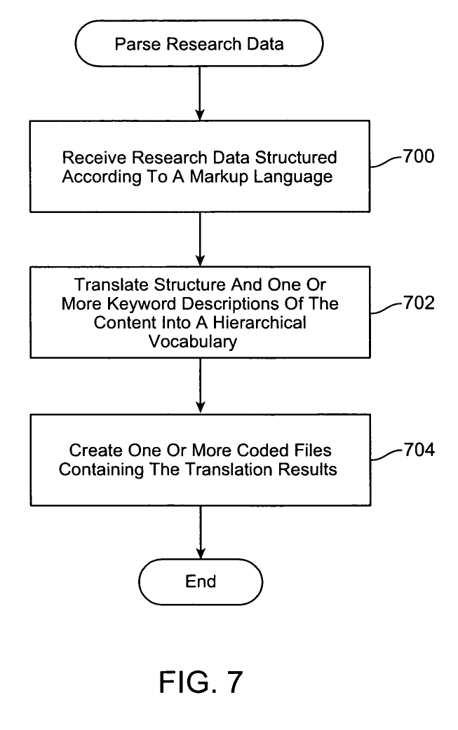

FIG. 7 is a flow diagram that illustrates a method for parsing research data in accordance with one embodiment of the present invention. The processes illustrated in FIG. 7 may be implemented in hardware, software, firmware, or a combination thereof. At 700, research data structured according to a markup language is received. At 702, the structure and one or more keyword descriptions of the content are translated into a hierarchical vocabulary. At 704, one or more coded files containing the translation results are created.

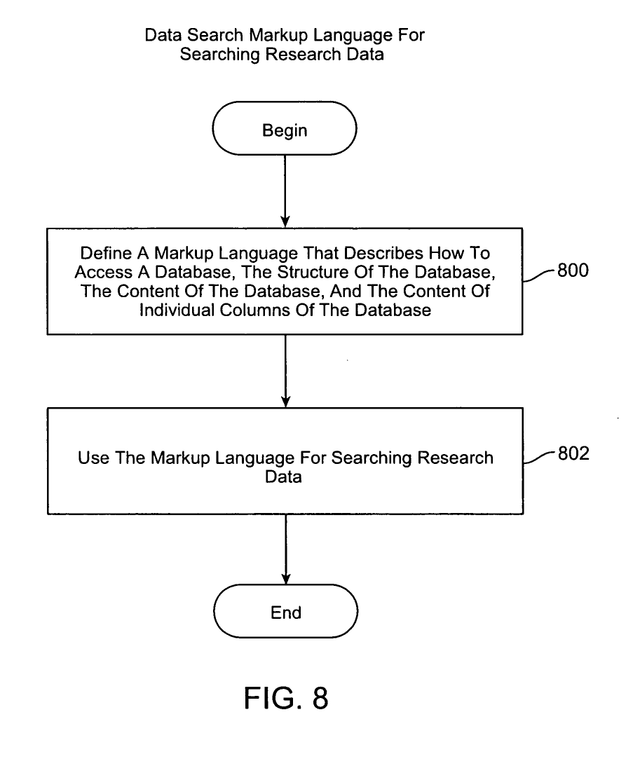

FIG. 8 is a flow diagram that illustrates a method for defining and using a data search markup language in accordance with one embodiment of the present invention. The processes illustrated in FIG. 8 may be implemented in hardware, software, firmware, or a combination thereof. At 800, a markup language that describes how to access a database, the structure of the database, the content of the database, and the content of individual columns of the database, is defined. At 802, the markup language is used for searching research data.

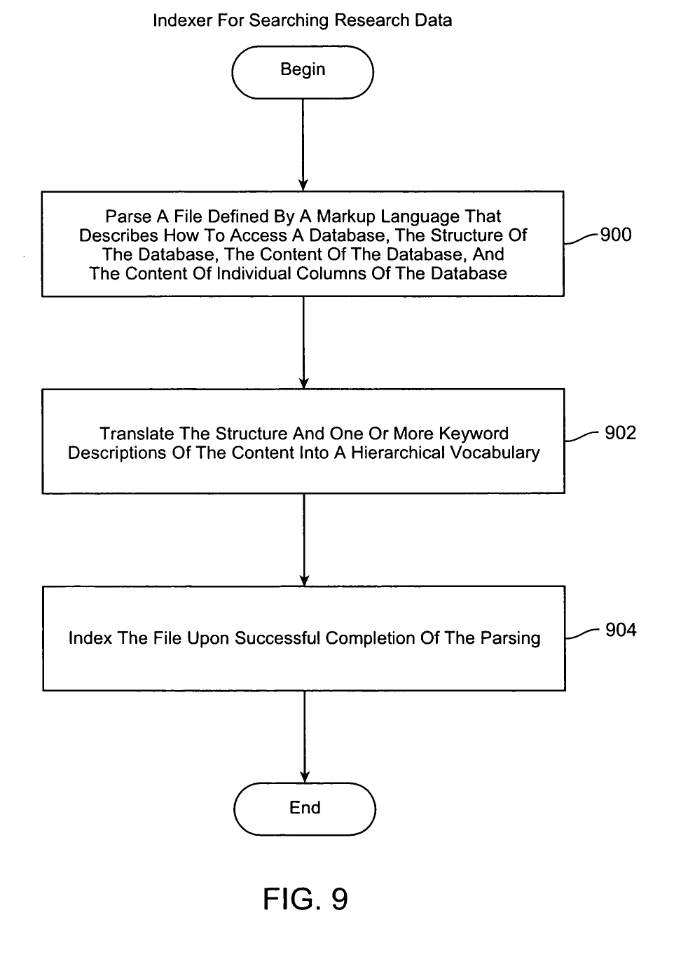

FIG. 9 is a flow diagram that illustrates indexing research data in accordance with one embodiment of the present invention. The processes illustrated in FIG. 9 may be implemented in hardware, software, firmware, or a combination thereof. At 900, a file defined by a markup language that describes how to access a database, the structure of the database, the content of the database, and the content of individual columns of the database, is parsed. At 902, the structure and one or more keyword descriptions of the content are translated into a hierarchical vocabulary. At 904, the file is indexed based upon successful completion of the parsing.

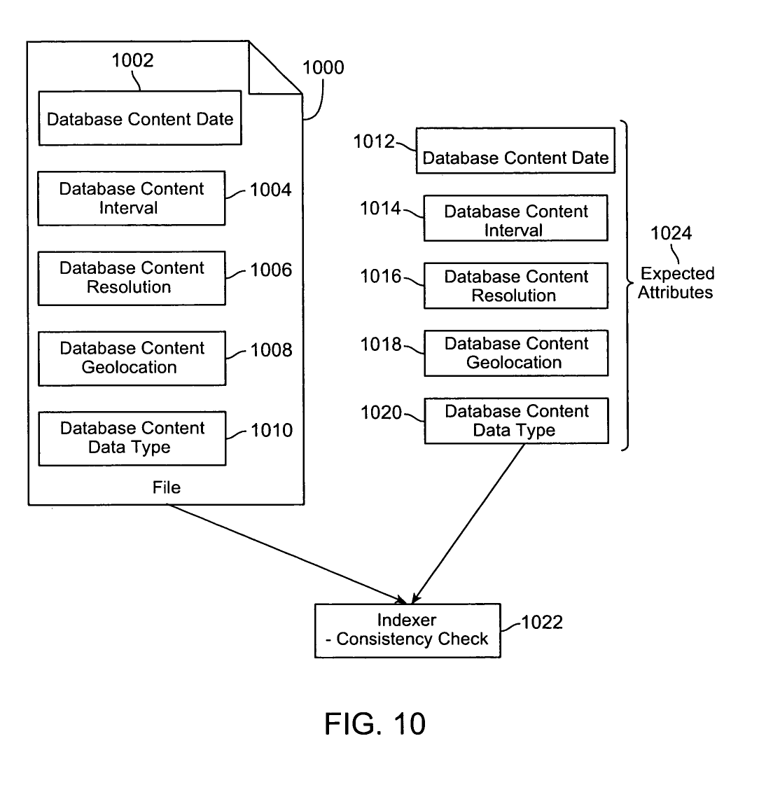

FIG. 10 is a block diagram that illustrates consistency checking in accordance with one embodiment of the present invention. An indexer comprises a consistency checker 1022 configured to compare expected attributes or characteristics 1024 of a database to be indexed 1000, with the actual attributes (1002-1010) of the database 1000. Example attributes include the database content date 1002, the database content interval 1004, the database content resolution, 1006, the database content geolocation 1008, and the database content type 1010.

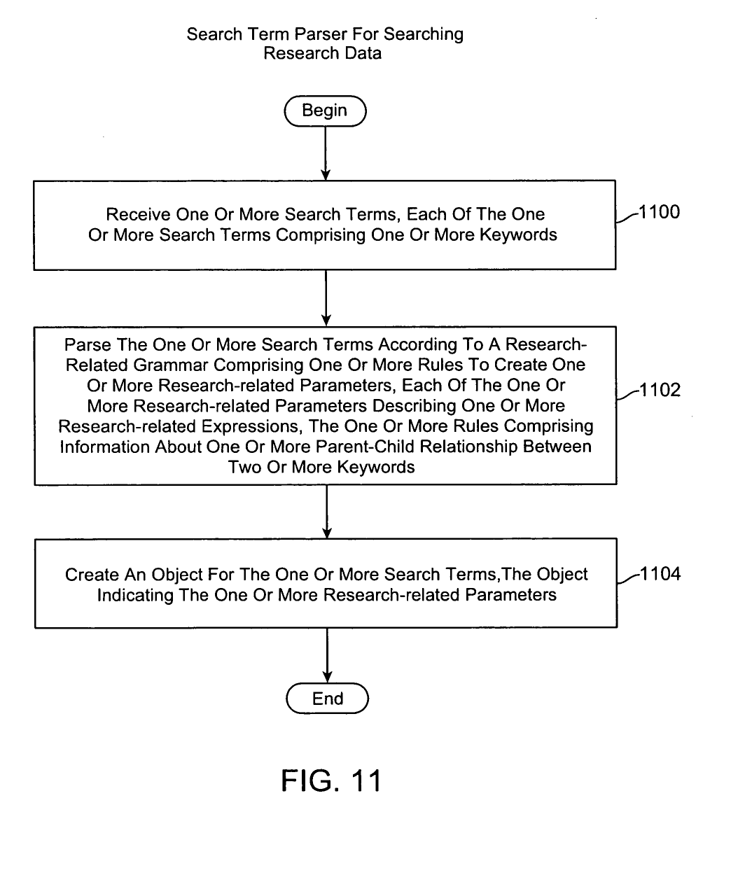

FIG. 11 is a flow diagram that illustrates searching research data in accordance with one embodiment of the present invention. The processes illustrated in FIG. 11 may be implemented in hardware, software, firmware, or a combination thereof. At 1100, on or more search terms are received, where each of the one or more search terms comprises one or more keywords. At 1102, the one or more search terms are parsed according to a research-related grammar comprising one or more rules to create one or more research-related parameters, where each of the one or more research-related parameters describes one or more research-related expressions. The one or more rules comprise information about one or more parent-child relationships between two or more keywords. At 1104, an object for the one or more search terms is created, where the object indicates the one or more research-related parameters.

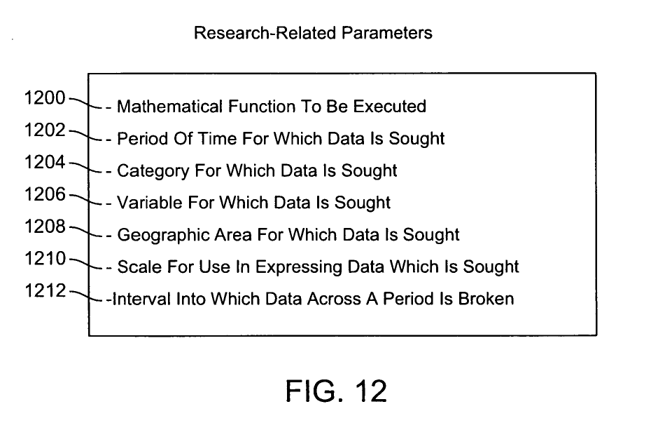

FIG. 12 is a block diagram that illustrates research-related parameters in accordance with one embodiment of the present invention. Example research-related parameters include a mathematical function to be executed 1200, a period of time for which data is sought 1202, a category for which data is sought 1204, a variable for which data is sought 1206, a geographic area for which data is sought 1208, a scale for use in expressing data which is sought 1210, and an interval into which data across a period is broken 1212.

Example mathematical functions to be executed (1200) include simple arithmetic functions such as addition, subtraction, division, and multiplication. Example mathematical functions to be executed (1200) also include statistical operations such as mean, median, standard deviation, and the like. Those of ordinary skill in the art will recognize other mathematical functions may be used.

Example periods of time for which data is sought include a period specified in terms of a beginning time and an ending time. The time may be expressed using various levels of granularity, such as millennium, decade, year, month, week, day, hour, minute, second, or fraction of a second. Another example period of time for which data is sought includes a period beginning with a specified time. Another example period of time for which data is sought includes a period ending with a specified time. Another example period of time for which data is sought includes a window of time that includes a specified time.

Example geographic areas for which data is sought include the universe, a galaxy, a planet, a hemisphere, a continent, a country, a state, a province, a county, a district, a metropolis, a city, a postal code, a geocode such as a (latitude, longitude) pair, a town, a village, a city block, or one or more addresses.

Example scales for use in expressing data which is sought include a linear scale or a logarithmic scale.

Example intervals into which data across a period is broken includes intervals delineated by millenniums, decades, years, months, weeks, days, hours, minutes, seconds, or fractions of a-second.

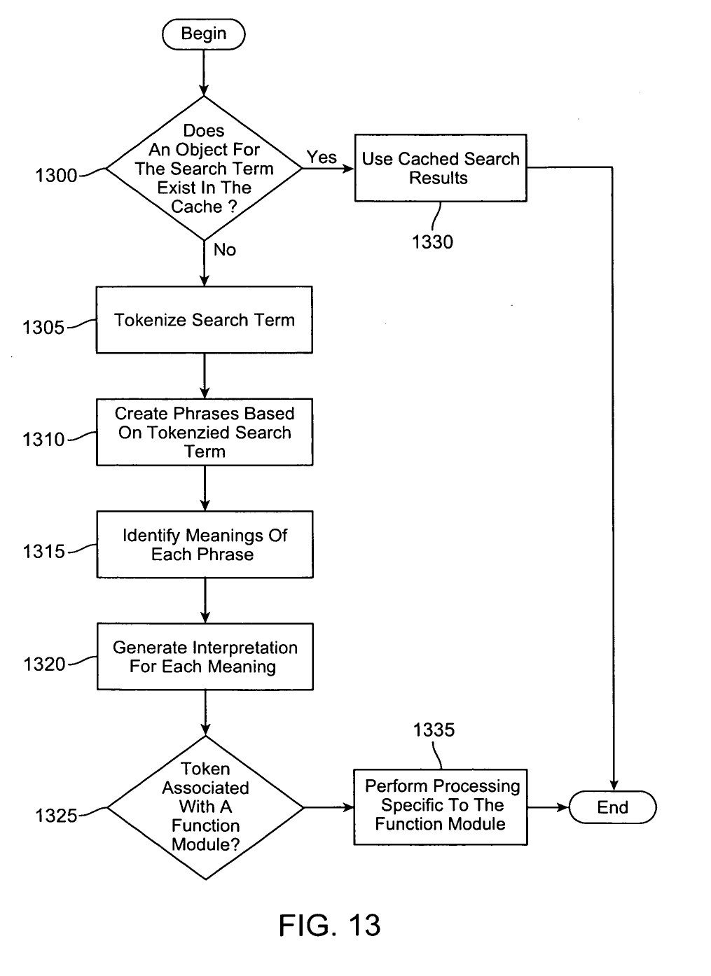

FIG. 13 is a flow diagram that illustrates a method for parsing a search term in accordance with one embodiment of the present invention. At 1300, a determination is made regarding whether an object for the search term exists in a cache. If an object for the search term exists in the cache, the search term has already been parsed and results have already been generated. In this case, the object in cache is used at 1330 by redirecting the user to a search results page or display. If an object for the search term does not exist in the cache, at 1305 the search term is tokenized by spaces and other whitespace characters to break the search term into individual words.

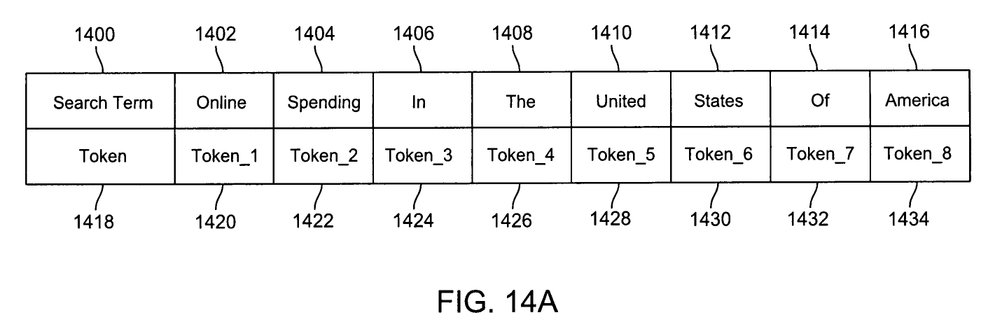

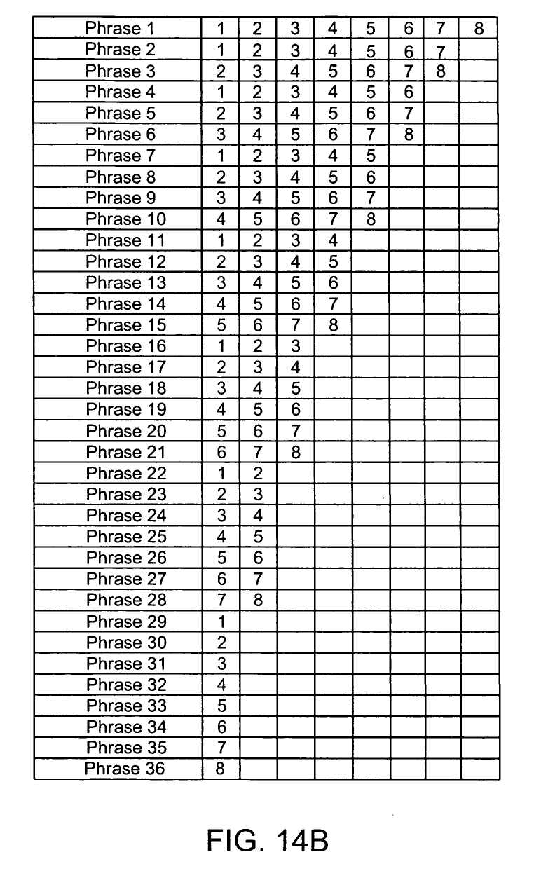

FIG. 14A is a block diagram that illustrates a tokenized search term in accordance with one embodiment of the present invention. As shown in FIG. 14A, the search term “Online spending in the United States of America” is parsed into tokens 1420-1434, representing individual words 1402-1416 of the search term 1400.

Referring again to FIG. 13, At 1310, one or more phrases are created based on the tokenized search term. Each phrase comprises two or more tokens separated by one or more spaces or blanks. These phrases are created using various token combinations. Continuing the example of FIG. 14A, example initial phrases are illustrated in FIG. 14B.

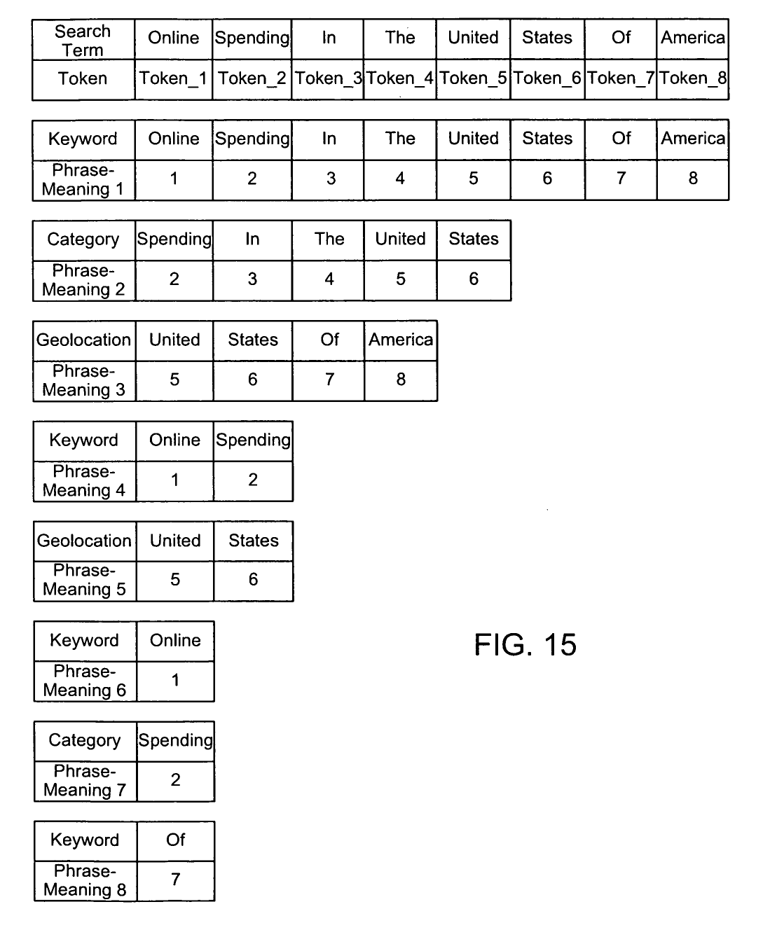

At 1315, meanings for each of the phrases are identified. The meanings are identified by looking them up in a knowledge base, resulting in an indication of whether a particular phrase represents one or more of the following: a category, a keyword, a geolocation, or the phrase does not exist in the knowledge base. The meanings for multiple phrases may be represented in a phrase-meaning table. Continuing the example of FIGS. 14A and 14B, an example phrase-meaning table is illustrated in FIG. 15. The phrase-meaning table associates each phrase with the meaning returned by the knowledge base.

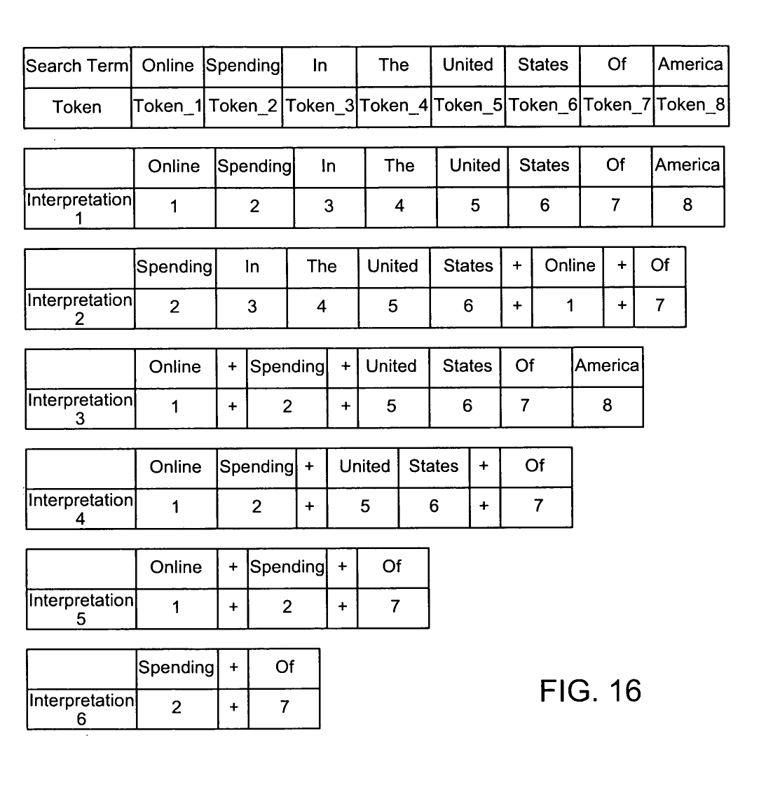

Referring again to FIG. 13, at 1320 one or more interpretations are generated for each phrase meaning. Continuing the example of FIGS. 14A 14B, and 15, example interpretations are shown in FIG. 16.

Referring again to FIG. 13, at 1325, for each interpretation, tokens that were not included in the interpretation are checked to see if they are associated with a function module. If token is associated with a function module, processing specific to the function module is performed at 1335.

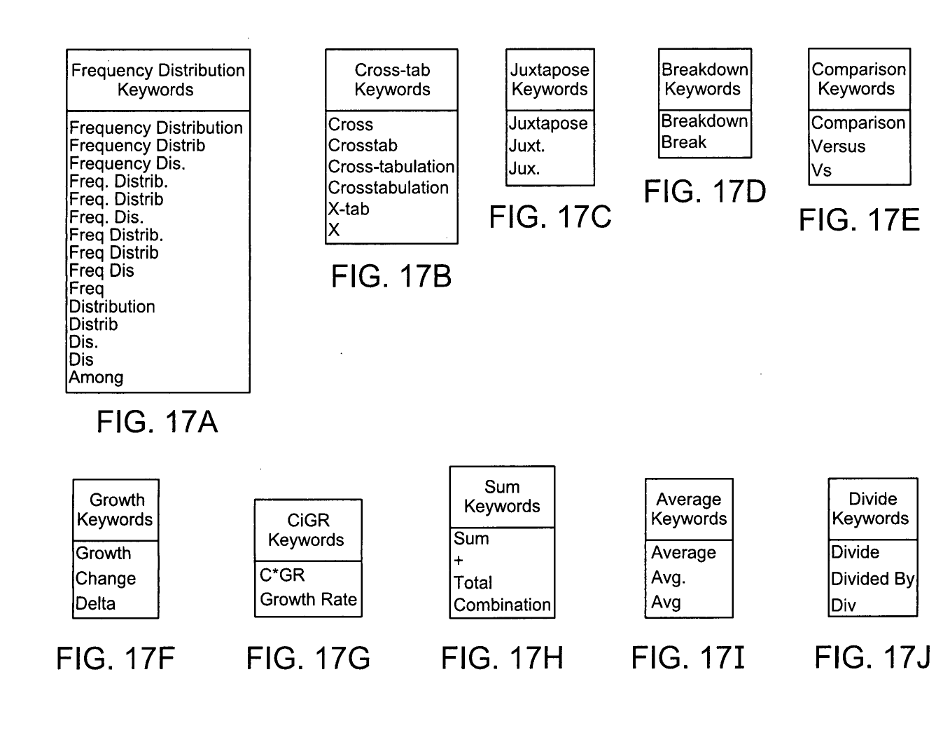

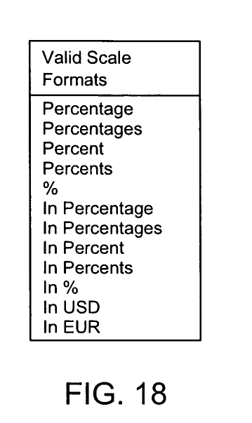

Example keywords associated with a “frequency distribution” function are illustrated in FIG. 17A. Table 1 shows an example output from the search term “gender vs. daily media consumption among aged 15-24.

TABLE 1

| | tv | print | radio | outdoor | online |
|---|---|---|---|---|---|
| men | 85% | 52% | 73% | 90% | 50% |
| women | 87% | 43% | 70% | 85% | 49% |

Example keywords associated with a “Cross-tab” function are illustrated in FIG. 17B. Table 2 shows an example output from the search term “cross-tab of US gender and age in 1995.”

TABLE 2

| | 15-25 | 26-35 | 36-45 | 46+ | CHECKSUM |
|---|---|---|---|---|---|
| Men | 20% | 15% | 40% | 25% | 100% |
| Women | 30% | 45% | 15% | 10% | 100% |
| CHECKSUM | 50% | 60% | 55% | 35% | |

Example keywords associated with a “Juxtapose” function are illustrated in FIG. 17C. Table 3 shows an example output from the search term “internet penetration against per capita online ad spending.”

TABLE 3

| | | Per Capita |
|---|---|---|
| | Internet | Online Ad |
| Country | Penetration | Spending |
| Austria | 57% | 1.45 Euro |
| Czech | 48% | 1.47 Euro |
| Republic | | |
| Slovenia | 48% | 2.02 Euro |
| Estonia | 48% | 1.89 Euro |
| Slovakia | 42% | 0.74 Euro |

Example keywords associated with a “Breakdown” function are illustrated in FIG. 17D. Table 4 shows an example output from the search term “breakdown of 1995 spending by media in percents.”

TABLE 4

| | | Spending |
|---|---|---|
| Year | Media | (%) |
| 1995 | TV | 40% |
| 1995 | Print | 30% |
| 1995 | Radio | 15% |
| 1995 | Outdoor | 5% |
| 1995 | Internet | 5% |
| 1995 | Cinema | 5% |

Example keywords associated with a “Comparison” function are illustrated in FIG. 17E. Table 5 shows an example output from the search term “comparison of Internet penetration between men and women between 1995-2000.”

TABLE 5

| Year | Men | Women |
|---|---|---|
| 1995 | 20% | 15% |
| 1996 | 25% | 20% |
| 1997 | 30% | 25% |
| 1998 | 35% | 30% |
| 1999 | 40% | 35% |
| 2000 | 45% | 40% |
| 2001 | 50% | 45% |
| 2002 | 55% | 52% |
| 2003 | 60% | 58% |
| 2004 | 65% | 64% |
| 2005 | 68% | 68% |

Example keywords associated with a “Growth” function are illustrated in FIG. 17F. Table 6 shows an example output from the search term “percentage growth in annual spending for 1995-2000.”

TABLE 6

| Year | Annual Spending Growth (%) |
|---|---|
| 1995 | 20% |
| 1996 | 25% |
| 1997 | 30% |
| 1998 | 35% |
| 1999 | 40% |
| 2000 | 45% |

Example keywords associated with a “CiGR” function are illustrated in FIG. 17G. Table 7 shows an example output from the search term “change in growth in annual spending for 1995-2000.”

TABLE 7

| Year | CAGR: Online Spending 1995-2000 |
|---|---|
| 1995 | 20% |
| 1996 | 25% |
| 1997 | 30% |
| 1998 | 35% |
| 1999 | 40% |
| 2000 | 45% |

Example keywords associated with a “Sum” function are illustrated in FIG. 17H. Table 8 shows an example output from the search term “total online ad spending in Austria, Czech Republic, Slovenia, Estonia, and Slovakia.”

TABLE 8

| Country | Per Capita Online Ad Spending |
|---|---|
| Austria | 1.45 Euro |
| Czech | 1.47 Euro |
| Republic | |
| Slovenia | 2.02 Euro |
| Estonia | 1.89 Euro |
| Slovakia | 0.74 Euro |

Example keywords associated with an “Average” function are illustrated in FIG. 17I. Table 9 shows an example output from the search term “Average CPM in Austria, Czech Republic, Slovenia, Estonia, and Slovakia.”

TABLE 9

| Country | Per Capita Online Ad Spending |
|---|---|
| Austria | 1.45 Euro |
| Czech | 1.47 Euro |
| Republic | |
| Slovenia | 2.02 Euro |
| Estonia | 1.89 Euro |
| Slovakia | 0.74 Euro |

Example keywords associated with a “Divide” function are illustrated in FIG. 17J. Table 10 shows an example output from the search term “Online ad spending by internet penetration in Austria, Czech Republic, Slovenia, Estonia, and Slovakia.”

TABLE 10

| | Online Ad Spending Divided |
|---|---|
| Country | By Internet Penetration |
| Austria | 1.45 Euro |
| Czech | 1.47 Euro |
| Republic | |
| Slovenia | 2.02 Euro |
| Estonia | 1.89 Euro |
| Slovakia | 0.74 Euro |

If a token is associated with a function module, additional analysis specific to the function module is performed on the search term. According to one embodiment of the present invention, if none of the tokens activate any function module identified in FIGS. 17A-17J, additional processing is performed by a “blank” function module.

According to one embodiment of the present invention, a function module determines whether a token string includes a specification of a date by receiving a set of valid date formats, determining whether the token string includes a substring that matches a valid date format, and removing any date prefix from the token substring. Example date prefixes include “in,” “during,” and “for.”

According to one embodiment of the present invention, a function module determines whether a token string includes a specification of a time interval by receiving a set of valid time interval formats, determining whether the token string includes a substring that matches a valid time interval format.

According to one embodiment of the present invention, a function module determines whether a token string includes a specification of a scale by receiving a set of valid scale formats, determining whether the token string includes a substring that matches a valid scale format. Example valid scale formats are shown in FIG. 18.

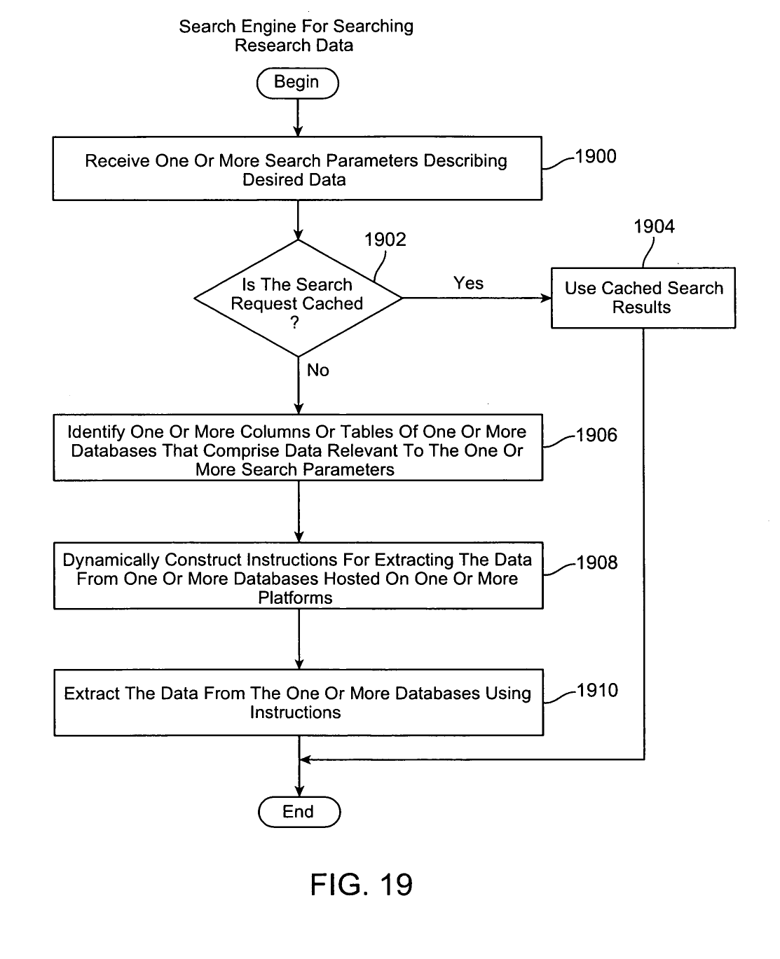

FIG. 19 is a flow diagram that illustrates a method for searching research data in accordance with one embodiment of the present invention. The processes illustrated in FIG. 19 may be implemented in hardware, software, firmware, or a combination thereof. At 1900, one or more search parameters describing desired data are received. At 1902, a determination is made regarding whether the search request is cached. The search request is cached if the search request has already been analyzed to create search results. If the search request is cached, at 1904, the cached search results are used. If the search request is not cached, at 1906, one or more columns of tables of one or more databases that comprise data relevant to the one or more search parameters, are identified. According to one embodiment of the present invention, a relatively high priority is accorded to datasets where relevant keywords appear in column-definition and column-group definitions. Keywords appearing in a row of a given column are accorded relatively low priority. A lowest priority is accorded to keywords that appear in the keywords describing the overall dataset.

Still referring to FIG. 19, at 1908, instructions for extracting the data from one or more databases hosted on the one or more platforms are dynamically constructed. At 1910, the data from the one or more databases is extracted using the instructions. According to one embodiment of the present invention, if the data comes from multiple databases, the data is assembled into one dataset.

According to one embodiment of the present invention, the number of search results is estimated prior to constructing instructions for extracting data from the one or more databases (1908).

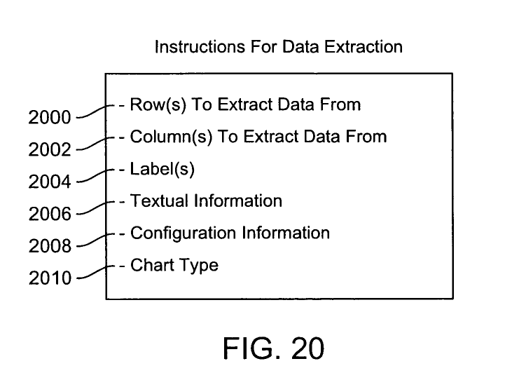

FIG. 20 is a block diagram that illustrates instructions for data execution in accordance with one embodiment of the present invention. Example instructions for data extraction include an indication of one or more rows to extract data from 2000, one or more columns to extract data from 2002, one or more labels associated with data to be extracted 2004, additional textual information to be displayed on a chart 2006, configuration information regarding a chart's display 2008, and chart type 2010. Example configuration information includes colors and borders. Example chart types include thumbnail, preview, and final.

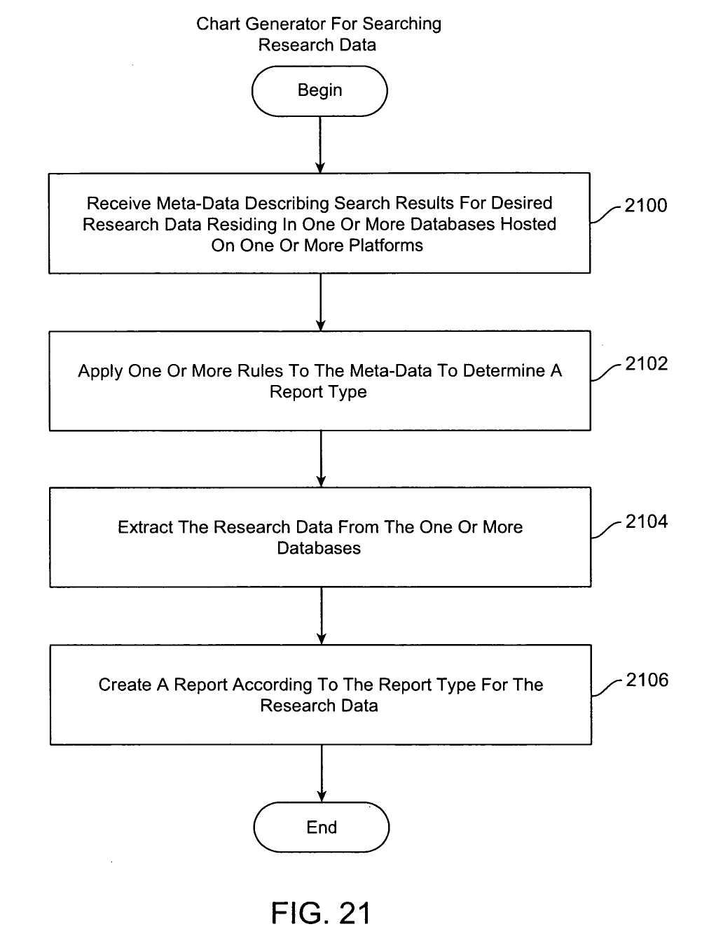

FIG. 21 is a flow diagram that illustrates generating a chart for rendering research data search results in accordance with one embodiment of the present invention. The processes illustrated in FIG. 21 may be implemented in hardware, software, firmware, or a combination thereof. At 2100, meta-data describing search results for desired research data residing in one or more databases hosted on one or more platforms, is received. At 2102, one or more rules are applied to the meta-data to determine a report type. The structure and content of a dataset are examined to intelligently determine an optimum presentation of the content. At 2104, the research data is extracted from the one or more databases. At 2106, a report is created according to the report type for the research data.

According to one embodiment of the present invention, step 2106 includes generating one or more thumbnail charts. According to another embodiment of the present invention, step 2106 includes generating one or more preview charts. According to another embodiment of the present invention, step 2106 includes generating one or more final charts.

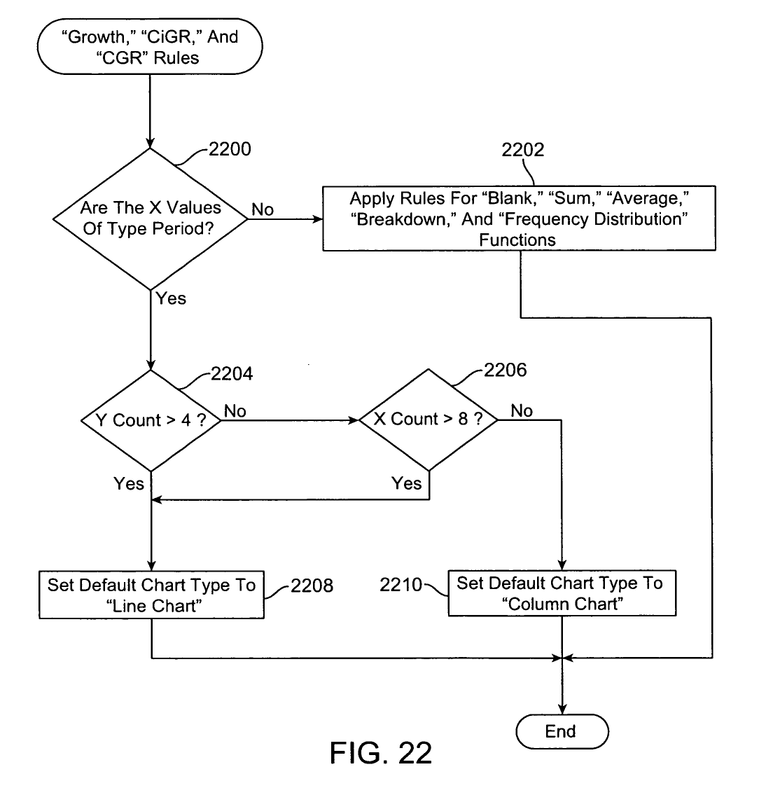

FIG. 22 is a flow diagram that illustrates determining a chart type for a “Growth,” “CiGR,” or “CGR” function in accordance with one embodiment of the present invention. FIG. 22 provides more detail for reference numeral 2102 of FIG. 21. According to one embodiment of the present invention, the default chart types for the “Growth,” “CiGR,” and “CGR” functions may be either a column chart or a line chart. Selecting between a column chart and a line chart proceeds as follows. At 2200, a determination is made regarding whether the X values of the dataset are of type period. If the X values of the dataset are not of type period, at 2202 the rules for the “Blank,” “Sum,” “Average,” “Breakdown,” and “Frequency Distribution” functions are applied. If the X values of the dataset are of type period, at 2204 a determination is made regarding whether the number of Y values is greater than a predetermined number. If the number of Y values is greater than a predetermined number, the default chart type is set to “line chart” at 2208. If the number of Y values is less than or equal to the predetermined number, at 2206 a determination is made regarding the number of X values. If the number of X values is greater than a second predetermined number, the default chart type is set to “line chart” at 2208. If the number of X values is less than or equal to the second predetermined number, the default chart type is set to “column chart” at 2210.

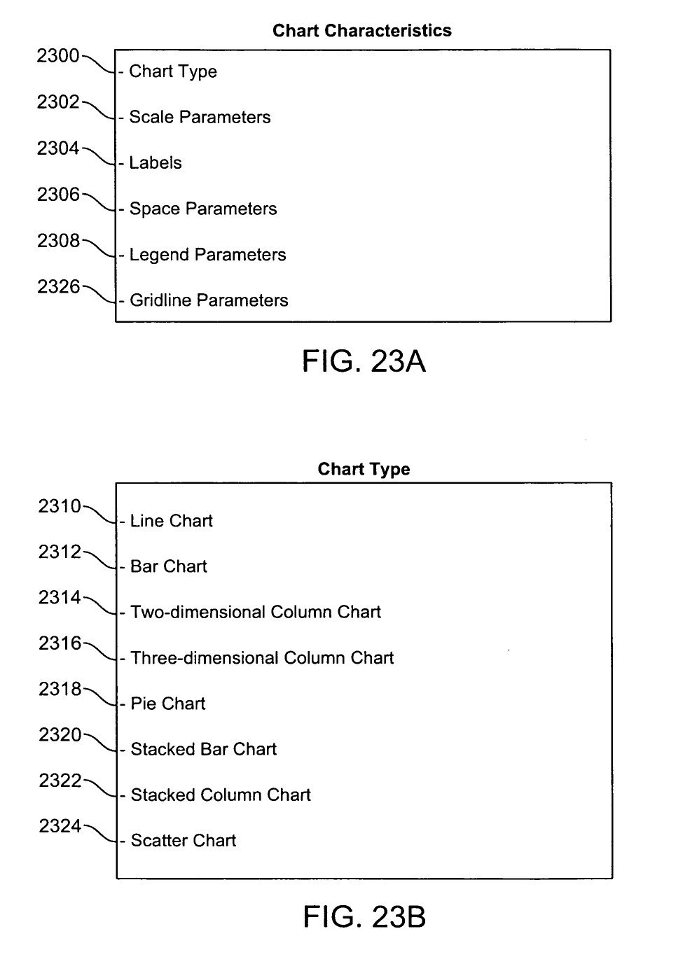

FIG. 23A is a block diagram that illustrates chart characteristics in accordance with one embodiment of the present invention. Example chart characteristics include chart type 2300, scale parameters 2302, labels 2304, space parameters 2306, legend parameters 2308, and Gridline parameters 2326. Example chart types are described below with reference to FIG. 23B. Example scale parameters include 1:1, 1:2, 1:3, 1:4, etc. Example scale parameters may also be expressed as fractions, e.g. ½, ⅓, ¼, ⅕, etc. Example legend parameters include the text of the legends. Example legend parameters also include the formatting and placement of the legend on the chart.

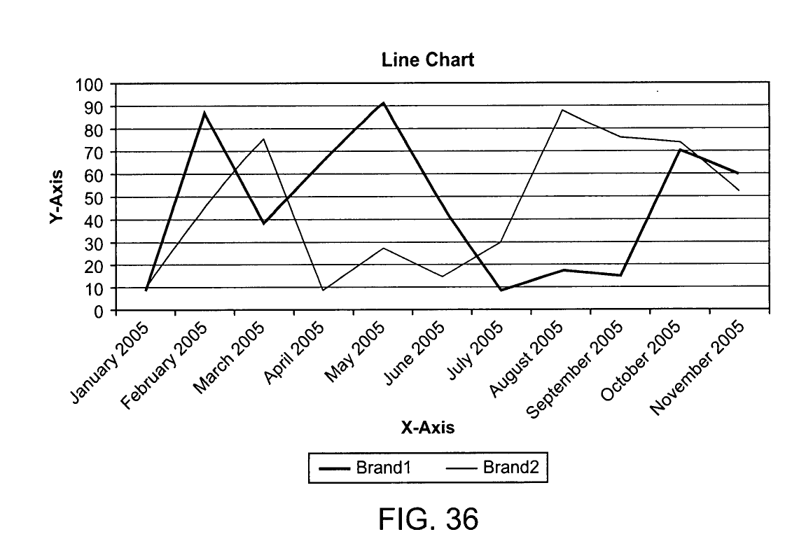

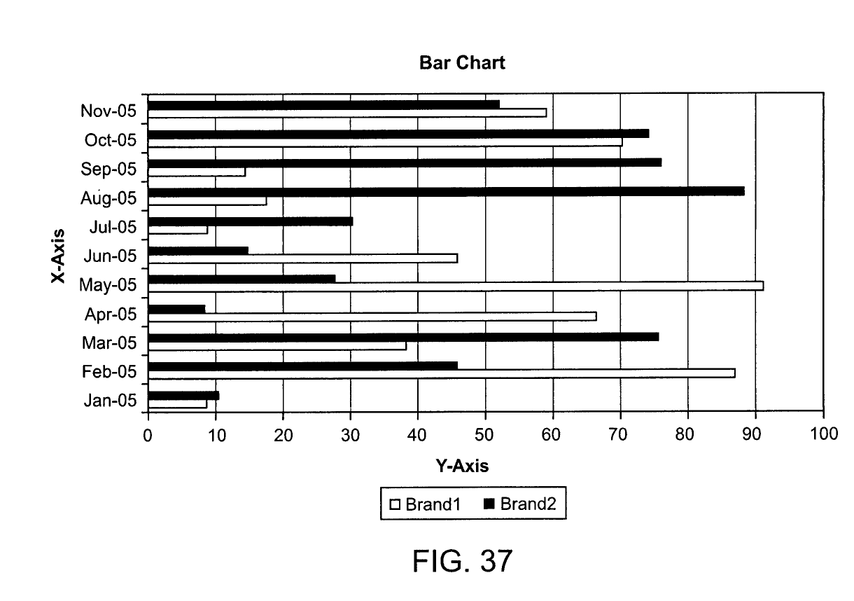

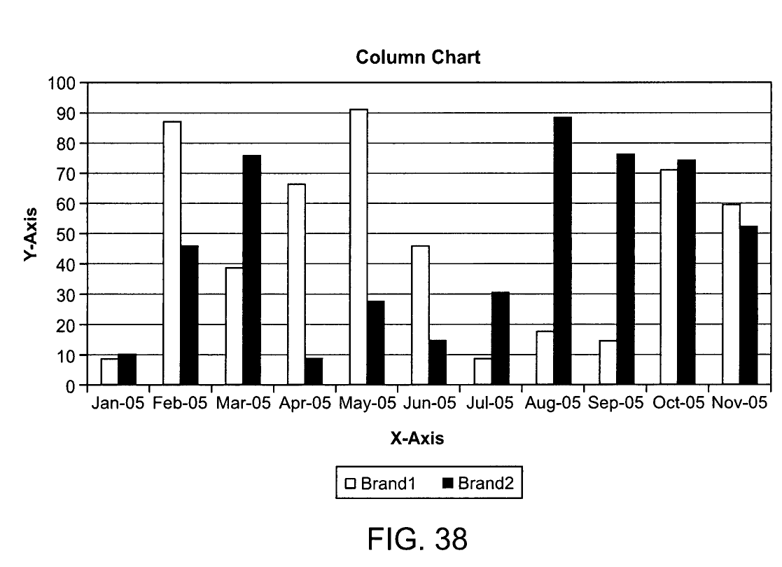

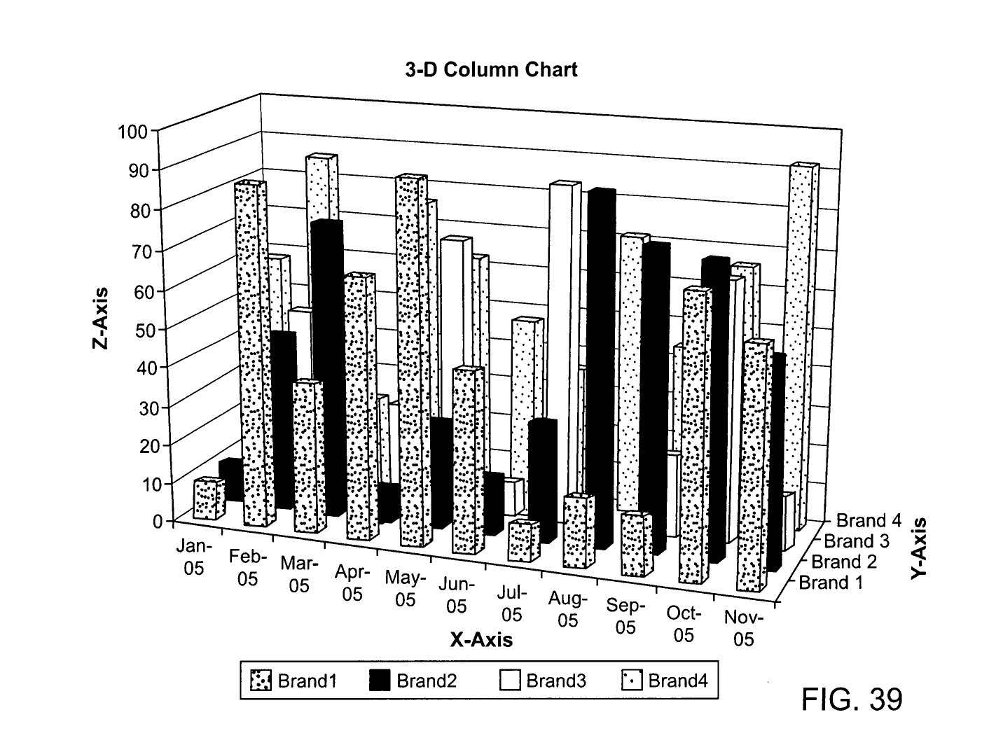

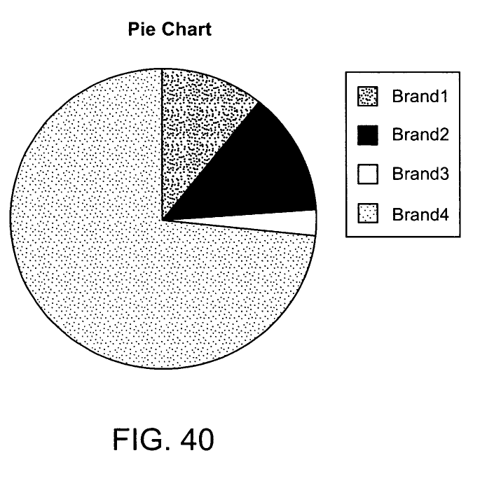

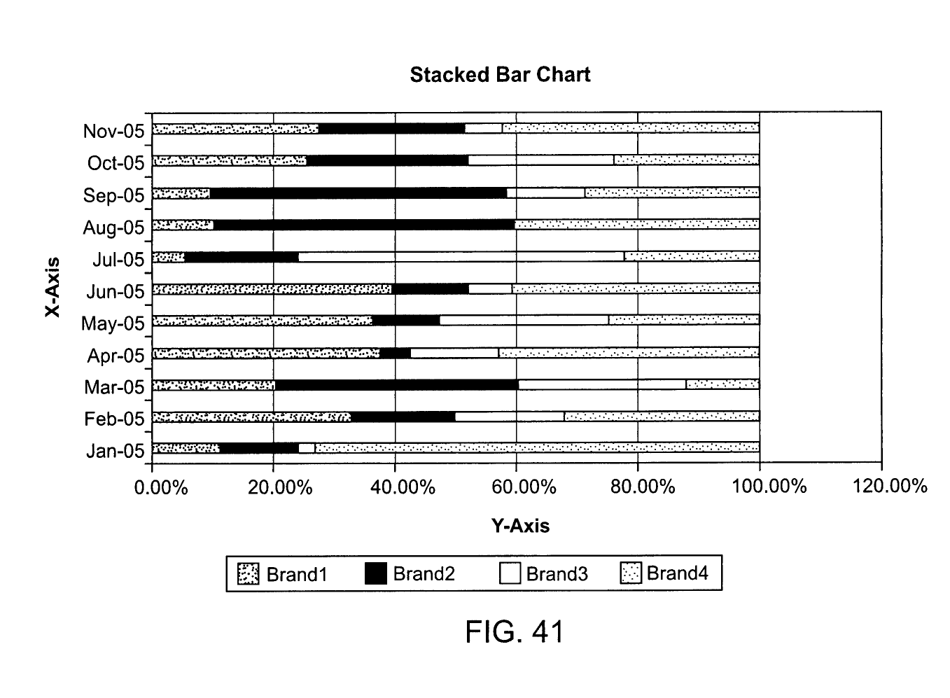

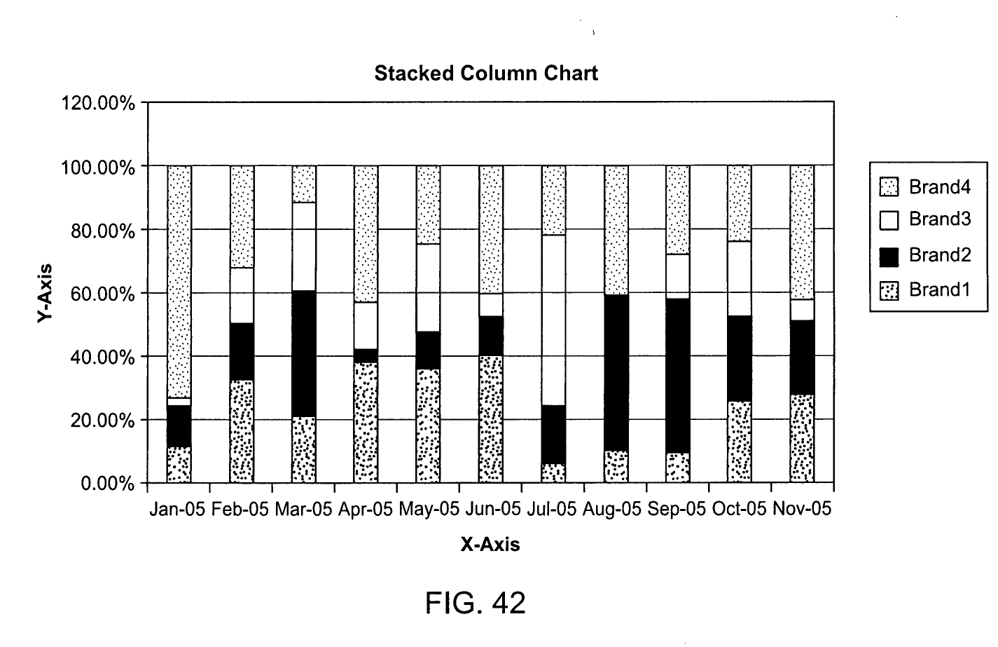

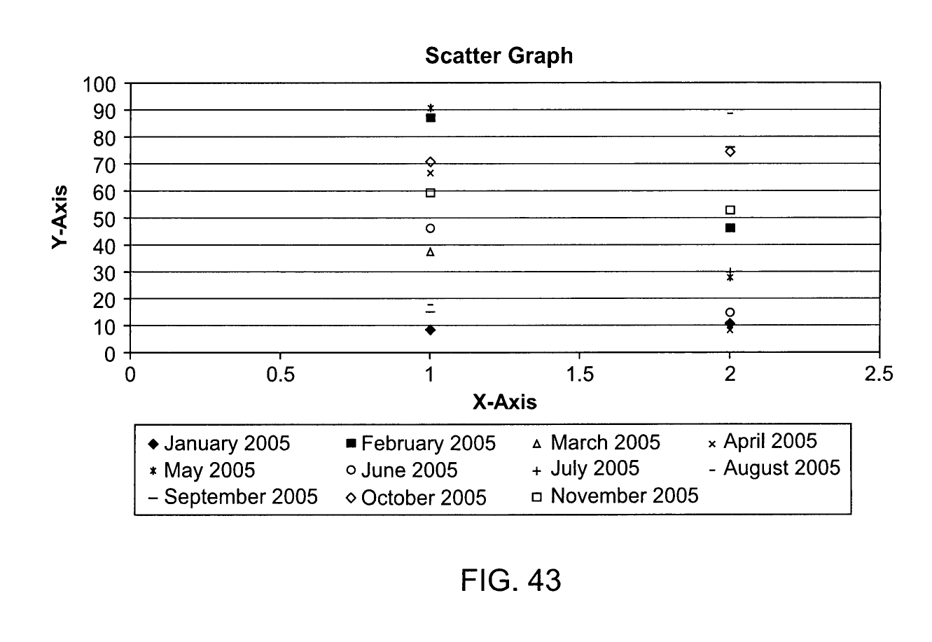

FIG. 23B is a block diagram that illustrates chart types in accordance with one embodiment of the present invention. Example chart types include a line chart 2310, a bar chart 2312, a two-dimensional column chart 2314, a three-dimensional column chart 2323, a pie chart 2318, a stacked bar chart 2320, a stacked column chart 2322, and a scatter chart 2324. FIG. 36 illustrates an example line chart. FIG. 37 illustrates an example bar chart. FIG. 38 illustrates and example two-dimensional column chart. FIG. 39 illustrates an example three-dimensional column chart. FIG. 40 illustrates an example pie chart. FIG. 41 illustrates an example stacked bar chart. FIG. 42 illustrates and example stacked column chart. FIG. 43 illustrates an example scatter chart.

According to one embodiment of the present invention, a line chart is a two-dimensional chart for use in displaying trends and time-series of data. Additional characteristics of line charts include line characteristics and point characteristics. Line characteristics describe the color, style and thickness of the line connecting the points along the chart. Point characteristics describe the color, style, and size of the point placed at each data point along the x-axis.

According to another embodiment of the present invention, a bar chart is a two-dimensional chart with categories along the y-axis and numerical values along the x-axis. Data is represented as a bar stretching horizontally across the chart area. Additional characteristics of bar charts include border characteristics, area characteristics, gap width, and sort order. Border characteristics describe the border around each bar (each data point). They describe the color, style, and thickness of the border. Area characteristics describe the interior of each bar (each data point). They describe the fill color of each bar. Gap width describes the width between each bar displayed on the chart. Sort order describes the order in which bars are sorted. According to one embodiment of the present invention, sorting is done by default in descending order. The sorting order is configurable.

According to another embodiment of the present invention, a column chart is a two-dimensional chart with categories or periods along the x-axis and numerical values along the y-axis. Data is represented as a bar stretching vertically up the chart area. Column charts may display multiple series of data simultaneously, provided they are displayed in the same scale. Additional characteristics of column charts include border characteristics, area characteristics, gap width, and sort order. Border characteristics describe the border around each bar (each data point). They describe the color, style, and thickness of the border. Area characteristics describe the interior of each bar (each data point). They describe the fill color of each bar. Gap width describes the width between each bar displayed on the chart. Sort order describes the order in which bars are sorted.

According to another embodiment of the present invention, a 3D-column chart is a three-dimensional chart with categories or periods along the x-axis, numerical values along the y-axis, and additional categories or series along the z-axis. Data is represented as a three-dimensional bar stretching vertically up the chart area. 3D-Column charts may display multiple series of data simultaneously, provided they are displayed in the same scale. Additional characteristics of 3D-column charts include border characteristics, area characteristics, gap width, gap depth, 3D-Rotation, and sort order. Border characteristics describe the border around each bar (each data point). They describe the color, style, and thickness of the border. Area characteristics describe the interior of each bar (each data point). They describe the fill color of each bar. Gap width describes the width between each bar displayed on the chart. Gap depth describes the amount of “vertical” (along the z-axis) space between different bars that are parallel (for identical x-axis values). 3D-Rotation describes a series of values denoting the rotation, pitch and yaw of the 3D chart itself. These values describe the angle from which the chart is viewed. Sort order describes the order in which bars are sorted.

According to another embodiment of the present invention, a pie chart is a one-dimensional chart that displays a round circle which is divided into segments, each segment denoting a value of the broader whole. Each data point is a segment on the circle. Pie charts can display only one series of data at a time. Additional characteristics of pie charts include pie characteristics, border characteristics, and area characteristics. Pie characteristics describe the border around the entire pie (color, style, and thickness), the rotation of the first segment of the pie from a natural 90-degree angle and the sort order for data points within the pie. Border characteristics describe the border around each bar (each data point). They describe the color, style, and thickness of the border. Area characteristics describe the interior of each bar (each data point). They describe the fill color of each bar.

According to another embodiment of the present invention, a stacked bar chart is a two-dimensional chart with categories along the y-axis and numerical values along the x-axis. Data is represented as a bar stretching horizontally across the chart area. Stacked bar charts display multiple series of data simultaneously, provided these series share x-values and are displayed on the same scale. Additional characteristics of stacked bar charts include border characteristics, area characteristics, gap width, category sort order, series sort order, and series line characteristics. Border characteristics describe the border around each bar (each data point). They describe the color, style, and thickness of the border. Area characteristics describe the interior of each bar (each data point). They describe the fill color of each bar. Gap width describes the width between each bar displayed on the chart. Specifically, gap width relates to the width of the gap between series. Category sort order describes the order in which bars are sorted. Series sort order describes the order in which series are sorted within a bar. Series line characteristics determines whether series lines connect each series in one bar (one data point) to the next related data point in the sequence. They also describe the characteristics of those series lines, such as color, thickness, and style.

According to another embodiment of the present invention, a stacked column chart is a two-dimensional chart with categories or periods along the x-axis and numerical values along the y-axis. Data is represented as a bar stretching vertically up the chart area. Stacked column charts display multiple series of data simultaneously, with one series being stacked on the other, provided that they share x-values and are displayed on the same scale. Additional characteristics of stacked bar charts include border characteristics, area characteristics, gap width, category sort order, series sort order, and series line characteristics. Border characteristics describe the border around each bar (each data point). They describe the color, style, and thickness of the border. Area characteristics describe the interior of each bar (each data point). They describe the fill color of each bar. Gap width describes the width between each bar displayed on the chart. Specifically, gap width relates to the width of the gap between series. Category sort order describes the order in which bars are sorted. Series sort order describes the order in which series are sorted within a bar. Series line characteristics determines whether series lines connect each series in one bar (one data point) to the next related data point in the sequence. They also describe the characteristics of those series lines, such as color, thickness, and style.

According to another embodiment of the present invention, a scatter chart is a two-dimensional chart which displays categories or series as data points. Scatter charts are used when each category or series has two numerical values that must be displayed. Scatter charts may display multiple series of data simultaneously, provided that they are displayed on the same scale. Additional characteristics of scatter charts include line characteristics and point characteristics. Line characteristics describe the color, style, and thickness of the line connecting the points along the chart. Point characteristics describe the color, style, and size of the data points for a given series.

According to one embodiment of the present invention, a default chart type is selected to reflect the structure and content of the data that the chart will display.

According to one embodiment of the present invention, different series are assigned different colors. According to another embodiment of the present invention, each series is assigned a different color in order of priority according to a color scheme.

According to another embodiment of the present invention, line styles are rotated when all colors of a particular color scheme have been used. If a chart has several series and all colors of a color scheme have been used, subsequent series are assigned a different line style, and the line color of subsequent series begins with the first color.

According to another embodiment of the present invention, a chart that displays multiple series also displays a legend showing which colors/formatting applies to which series. According to another embodiment of the present invention, the positioning of the legend on the chart is based at least in part on the number of series present on the chart.

According to another embodiment of the present invention, a chart displays the data source for the information displayed in the chart.

According to another embodiment of the present invention, display of one or more of the following is based at least in part on the chart type: chart title, chart area border, x-axis title, x-axis major tick marks, x-axis minor tick marks, x-axis labels, y-axis title, y-axis major tick marks, y-axis minor tick marks, y-axis labels, z-axis title, z-axis major tick marks, z-axis minor tick marks, z-axis labels, major gridlines, minor gridlines, data point titles, and data point values.

According to another embodiment of the present invention, the scale of the numerical axis (x- or y-axis depending on the chart type) is determined based at least in part on the values of the data points in the final dataset. The scale of the axis is determined by one or more of the following:
Minimum—the lowest value of the numerical axis possibly displayed on the chart
Maximum—the highest value of the numerical axis possibly displayed on the chart
Major interval—the distance between major gridlines and major tick marks on the chart
Minor interval—the distance between minor gridlines and minor tick marks on the chart
Logarithmic Scale—a determination that the scale on the axis is a logarithmic scale
Scale format—the format in which the scale is displayed

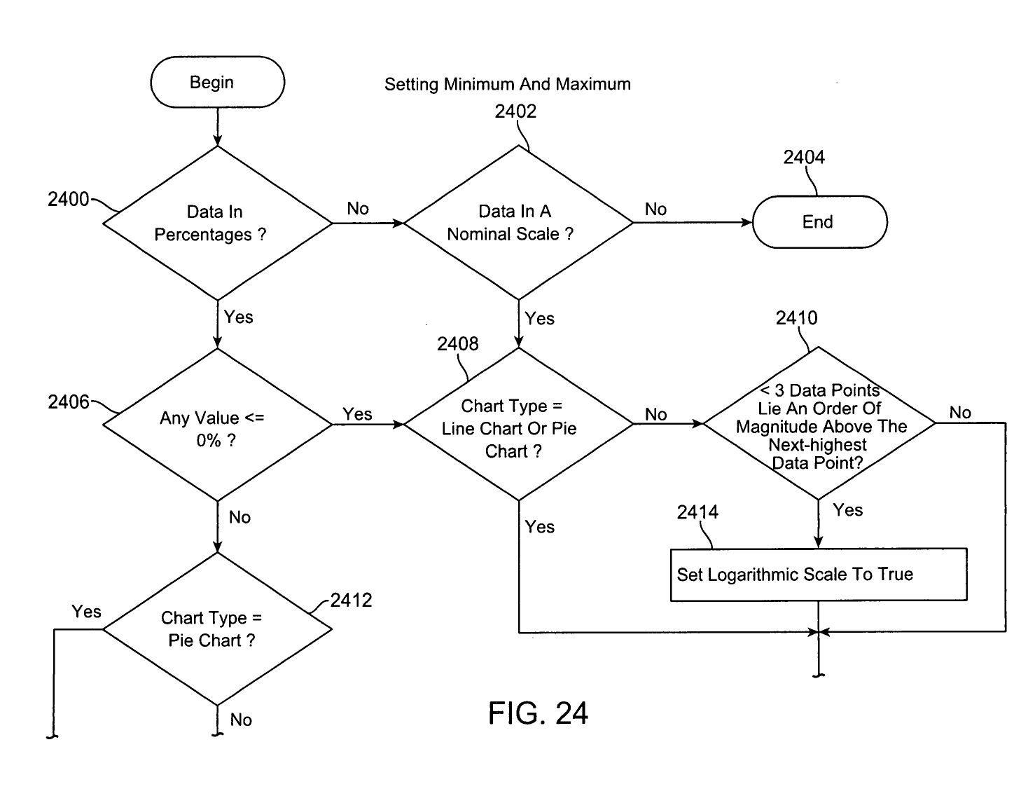

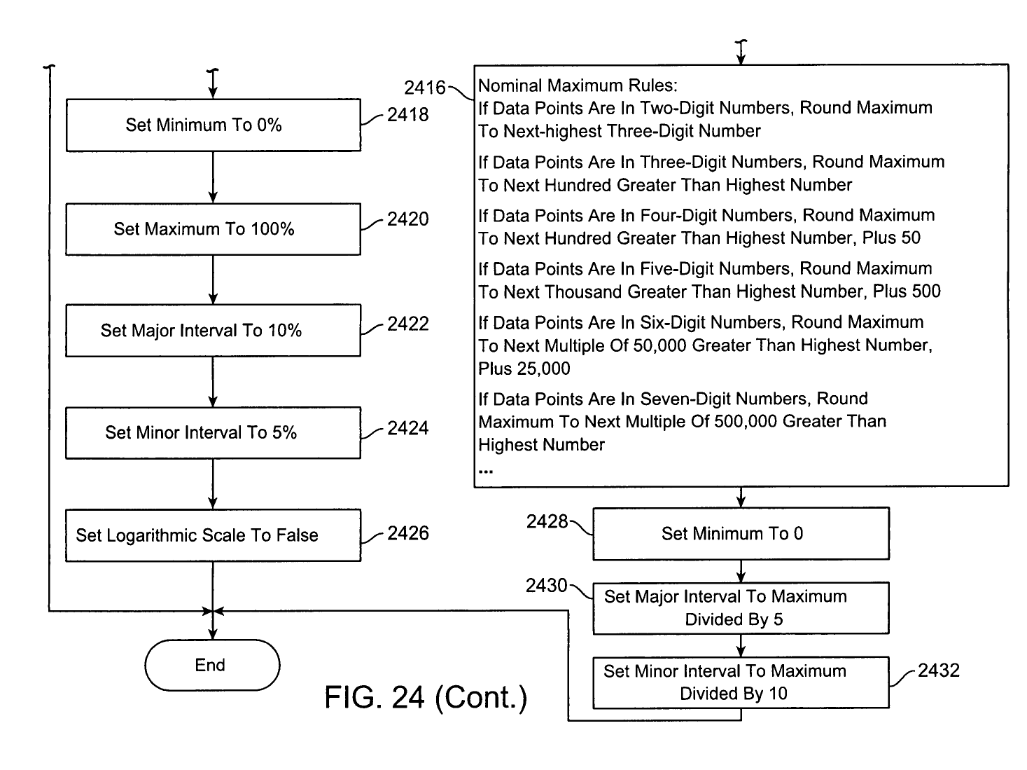

FIG. 24 is a flow diagram that illustrates a method for setting maximum and minimum values for a scale in accordance with one embodiment of the present invention. At 2400, a determination is made regarding whether chart data is expressed in terms of percentages. If the chart data is expressed in terms of percentages, at 2406, a determination is made regarding whether any chart value is less than or equal to 0%. If no chart value is less than or equal to 0%, a determination is made at 2412 regarding whether the chart type is a pie chart. If the chart type is not a pie chart, the minimum value for the scale is set to 0% at 2418, the maximum value for the scale is set to 100% at 2420, the major interval for the scale is set to 10% at 2422, the minor interval for the scale is set to 5% at 2424, and a logarithmic scale flag is set to false at 2426.

Still referring to FIG. 24, if chart data is expressed in a nominal scale at 2402 or if at least one chart data value is less than or equal to 0% at 2406, at 2408 a determination is made regarding whether the chart type is line chart or pie chart. If the chart type is not line chart or pie chart, at 2410 a determination is made regarding whether less than three data points lie an order of magnitude above the next-highest data point. If less than three data points lie an order of magnitude above the next-highest data point, a flag indicating a logarithmic scale is set to true at 2414. At 2416, the maximum value for nominal data values is set, based at least in part on the number of digits used to express each data point. At 2428, the minimum value for nominal data values is set to zero. At 2430, the major interval for nominal data values is set to the maximum value divided by five. At 2432, the minor interval for nominal data values is set to the maximum value divided by ten.

According to one embodiment of the present invention, the title of the chart is determined by removing from the search term, keywords that were not found in the relevant dataset.

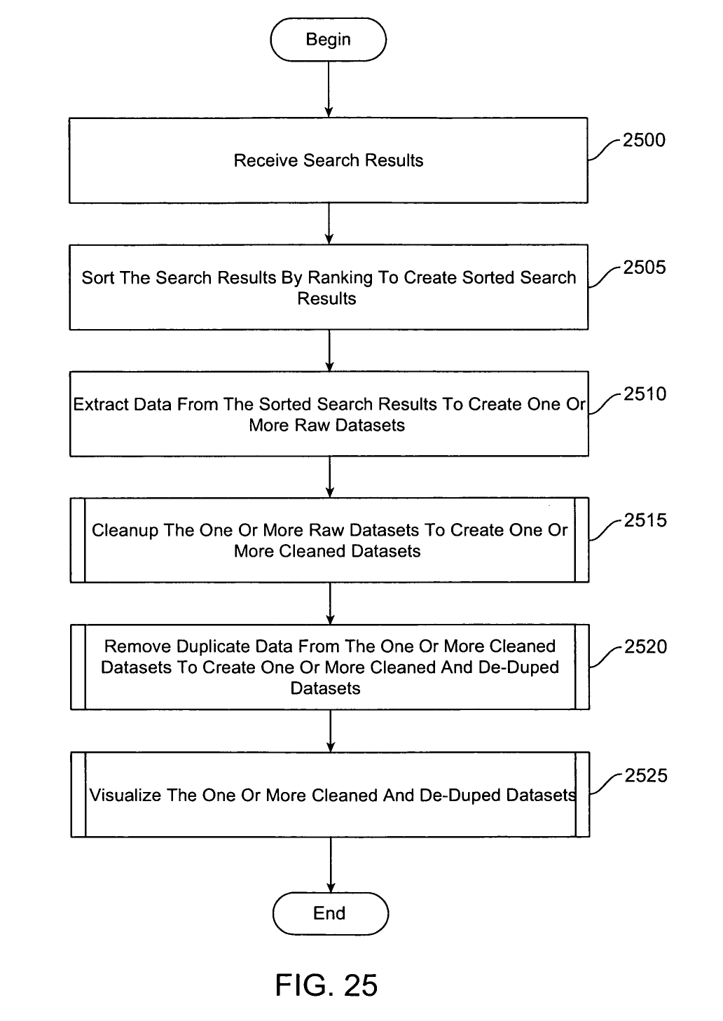

FIGS. 25-34 illustrate additional methods for creating reports suitable for display to a user in accordance with example embodiments of the present invention. The embodiments of the present invention illustrated in FIGS. 25-34 are separate from the embodiments of the present invention illustrated in FIGS. 22 and 24. Specifically, FIGS. 25-34 contemplate determining a chart type for a “Growth,” “CiGR,” or “CGR” function differently than that contemplated by FIG. 22. Likewise, FIGS. 25-34 contemplate setting maximum and minimum values for a scale differently than that contemplated by FIG. 24.

FIG. 25 is a flow diagram that illustrates a method for creating a report based on search results in accordance with one embodiment of the present invention. The processes illustrated in FIG. 25 may be implemented in hardware, software, firmware, or a combination thereof. At 2500, one or more search results are received. At 2505, the search results are sorted by ranking to create one or more sorted search results. In other words, the search results are sorted based at least in part on how closely the search results matched the search query entered by the user. At 2510, data is extracted from the sorted search results to create one or more raw datasets. At 2515, the one or more raw datasets are cleaned up to create one or more cleaned datasets. At 2520, duplicate data is removed from the one or more cleaned datasets to create one or more cleaned and de-duped datasets. At 2525, the one or more cleaned and de-duped datasets are visualized or formatted for display to the user.

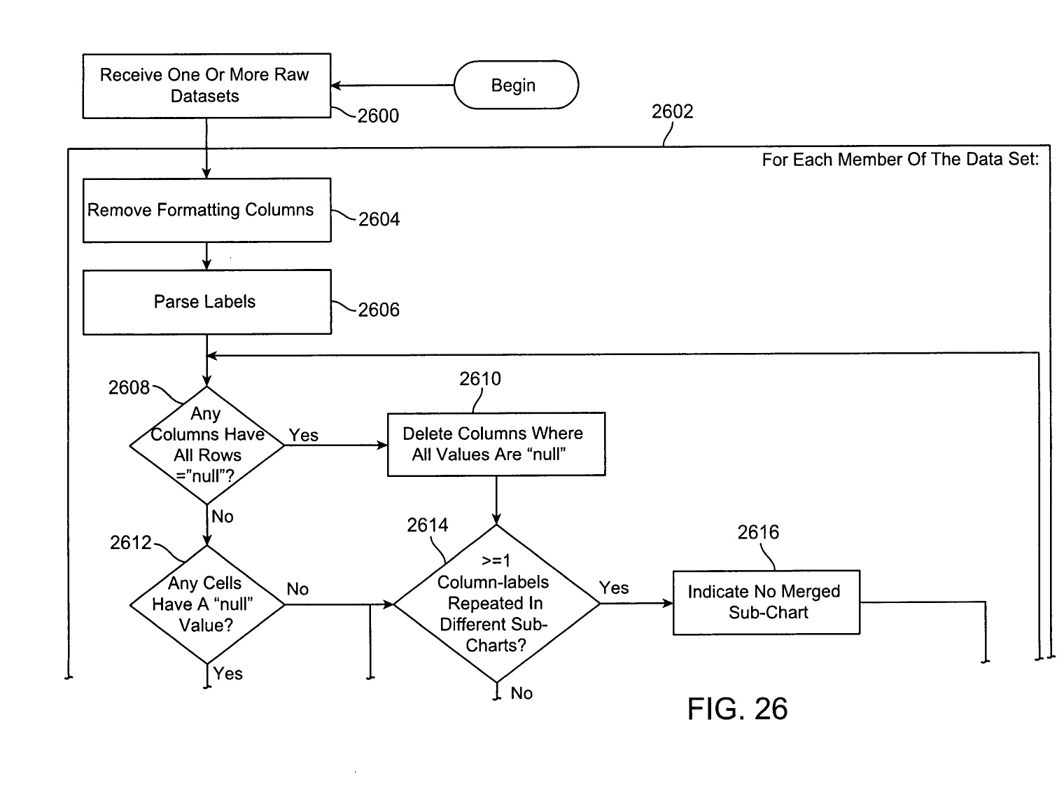

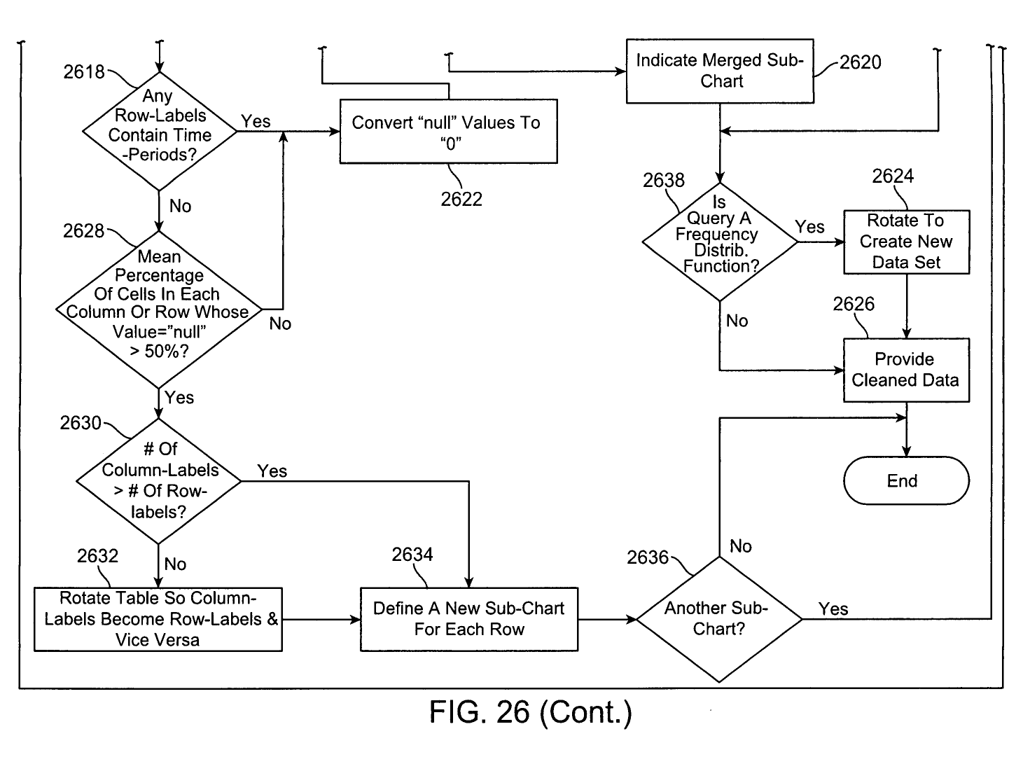

FIG. 26 is a flow diagram that illustrates a method for data cleanup in accordance with one embodiment of the present invention. FIG. 26 provides more detail for reference numeral 2515 of FIG. 25. The processes illustrated in FIG. 26 may be implemented in hardware, software, firmware, or a combination thereof. At 2600, one or more raw datasets are received. The processes in reference numeral 2602 are performed for each of the one or more raw datasets. At 2604, formatting characters are removed from columns in the raw dataset. At 2606, labels in the dataset are parsed. At 2608, a determination is made regarding whether any of the columns in the dataset have rows where each cell of the row has a “null” value. For the purposes of this disclosure, a “null” value indicates an empty or undefined value. At 2612, a determination is made regarding whether any cells have a “null” value. At 2618, a determination is made regarding whether any row labels contain time-periods. At 2628, a determination is made regarding whether the mean percentage of cells in each column or row whose values are the “null” value, is greater than 50%. At 2630, a determination is made regarding whether the number of column-labels is greater than the number of row-labels.

Still referring to FIG. 26, if at 2608, any of the columns in the dataset have rows where each cell of the row has a “null” value, columns where all values are deleted at 2610. If at 2612 no cells have a “null” value, at 2614 a determination is made regarding whether one or more column-labels are repeated in different sub-charts. If one or more column-labels are repeated in different sub-charts, at 2616 an indication of no merged sub-chart is made. Otherwise, at 2620 an indication of a merged sub-chart is made. At 2638, a determination is made regarding whether the query is a frequency distribution function. If the query is a frequency distribution function, at 2624 the data is rotated to create a new dataset. If the query is not a frequency distribution function, the data is not rotated. At 2626, clean data is provided.

If at 2618 any row labels contain time-periods, “null” values are converted to “0” at 2622. If at 2628 the mean percentage of cells in each column or row whose values are the “null” value, is less than or equal to 50%, “null” values are converted to “0” at 2622.

If at 2630 the number of column-labels is less than or equal to the number of row-labels, the table is rotated at 2632 so that column-labels become row-labels, and row-labels become column-labels. At 2634, a new sub-chart is defined for each row. At 2636, a determination is made regarding whether there is another sub-chart in the dataset. If there is another sub-chart in the dataset, it is processed beginning at reference numeral 2608. If there are no more sub-charts in the dataset, processing terminates.

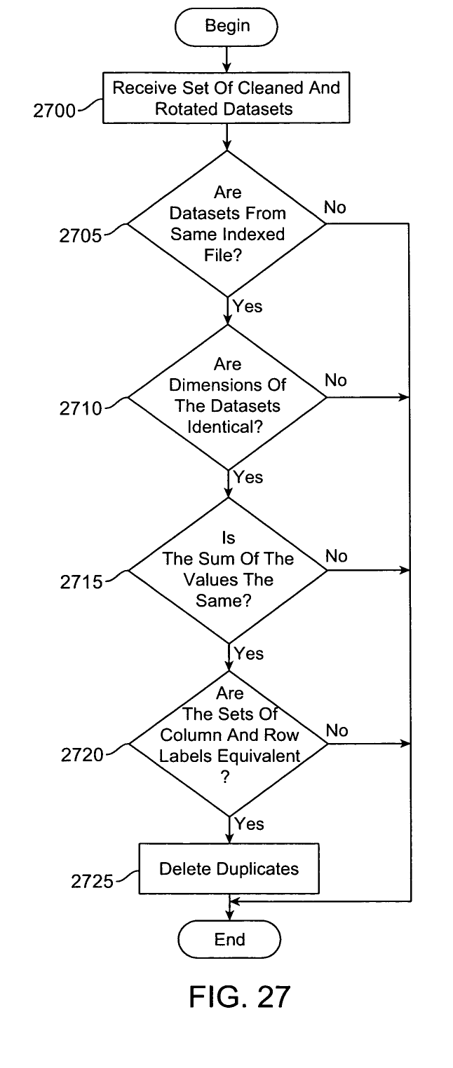

FIG. 27 is a flow diagram that illustrates a method for removing duplicate data in accordance with one embodiment of the present invention. FIG. 27 provides more detail for reference numeral 2520 of FIG. 25. The processes illustrated in FIG. 27 may be implemented in hardware, software, firmware, or a combination thereof. At 2700, a set of cleaned and rotated datasets is received. At 2705, a determination is made regarding whether the datasets are from the same indexed file. If the datasets are from the same indexed file, at 2710 a determination is made regarding whether the dimensions of the datasets are identical. If the dimensions of the datasets are identical, at 2715 a determination is made regarding whether the sum of the values is the same. If at 2715 the sum of the values is the same, at 2720 a determination is made regarding whether the sets of column and row labels are equivalent. If the sets of column and row labels are equivalent, at 2725 duplicates are deleted. Duplicates are not deleted at 2725 if the datasets are from the same indexed file, if the dimensions of the datasets are identical, if the sum of the values is the same, or if the sets of column and row labels are equivalent.

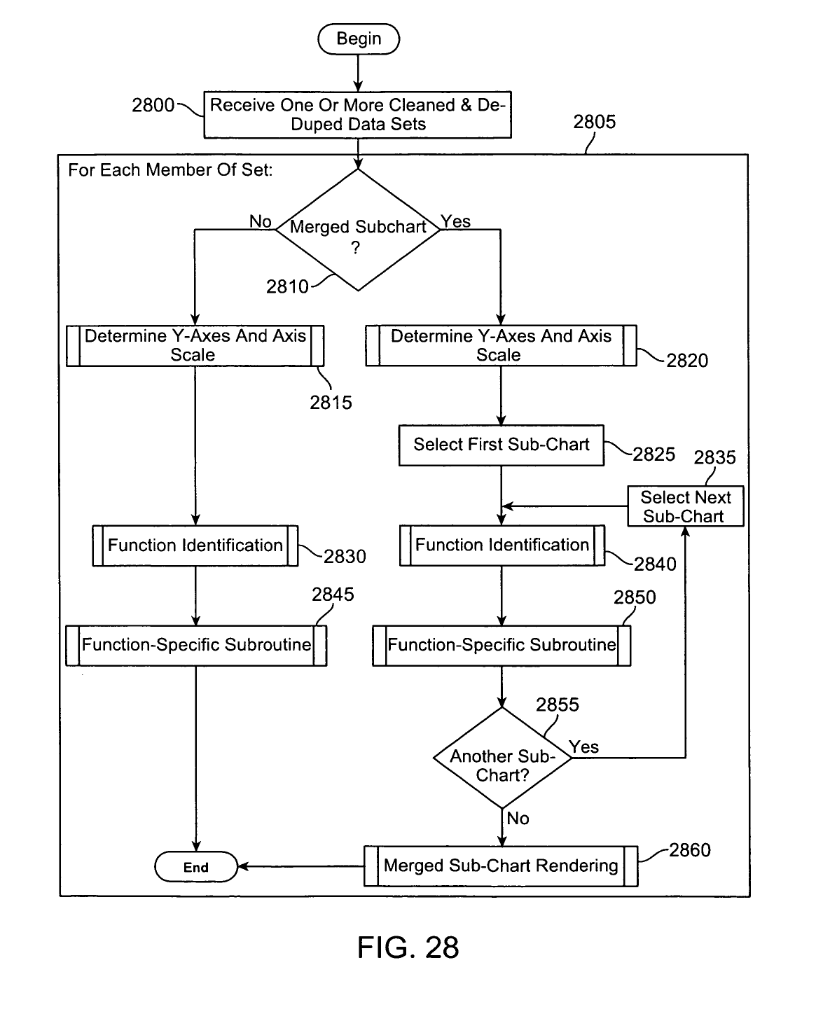

FIG. 28 is a flow diagram that illustrates a method for data visualization in accordance with one embodiment of the present invention. FIG. 28 provides more detail for reference numeral 2525 of FIG. 25. The processes illustrated in FIG. 28 may be implemented in hardware, software, firmware, or a combination thereof. At 2800, one or more cleaned and de-duped datasets is received. The processes identified by reference numeral 2805 are performed for each dataset. At 2810, a determination is made regarding whether the dataset includes one or more merged sub-chart. If the dataset does not include one or more merged sub-chart, y-axis and axis scale are determined at 2815, a function is identified at 2830, and any function-specific subroutines are performed at 2845.

If at 2810 it is determined that the dataset includes one or more merged sub-chart, y-axis and axis scale are determined at 2820. At 2825, a first sub-chart is selected. At 2840, a function is identified. At 2850, any function-specific subroutines are performed. At 2855, a determination is made regarding whether there is another sub-chart. If there is another sub-chart, the next sub-chart is selected at 2835, and processing of the next sub-chart continues at 2840. If there are no more sub-charts, the merged sub-charts are rendered at 2860.

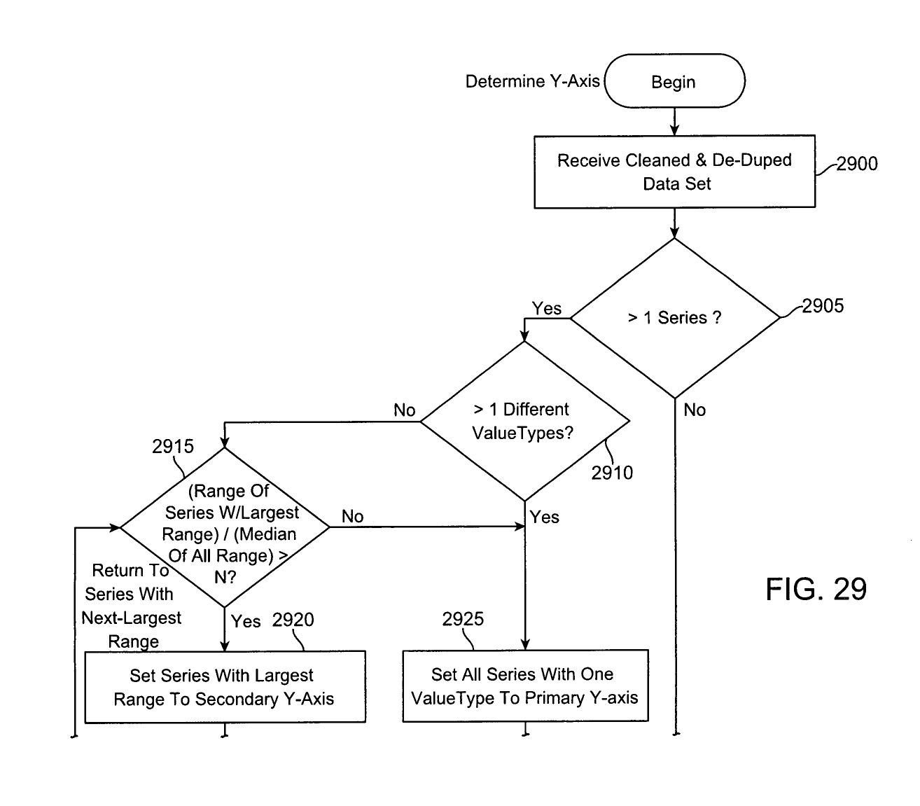

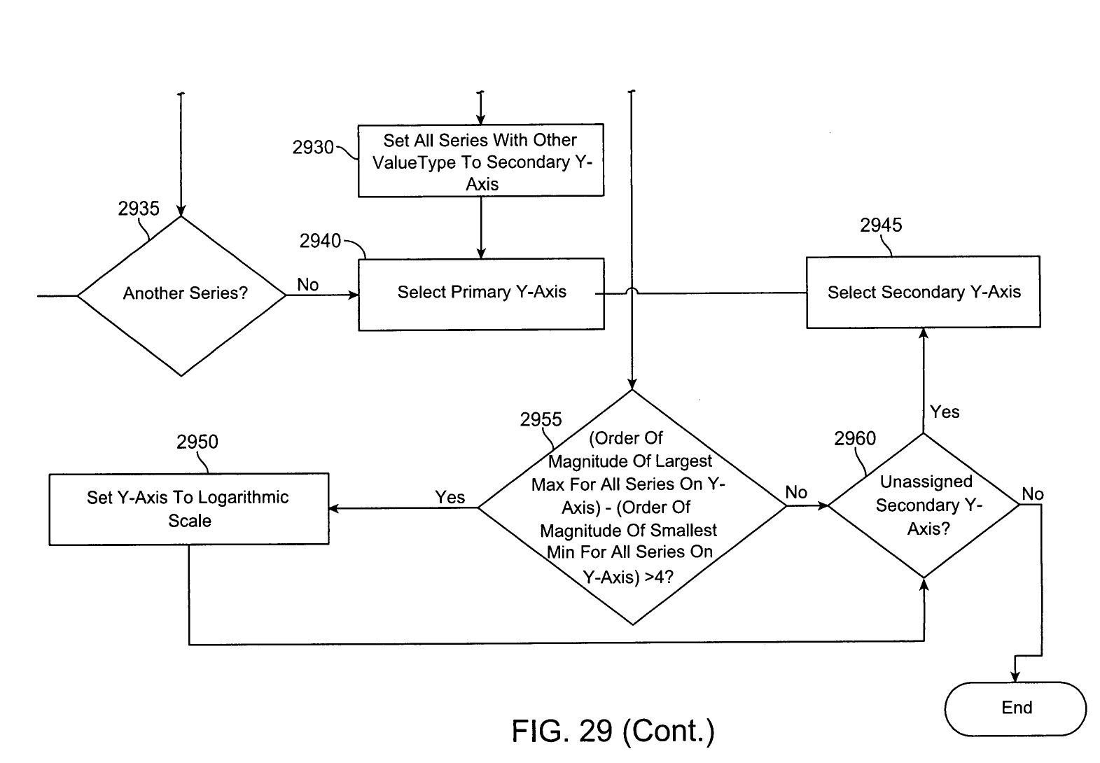

FIG. 29 is a flow diagram that illustrates a method for determining y-axis and axis scale in accordance with one embodiment of the present invention. FIG. 29 provides more detail for reference numerals 2815 and 2820 of FIG. 28. The processes illustrated in FIG. 29 may be implemented in hardware, software, firmware, or a combination thereof. At 2900, a cleaned and de-duped dataset is received. At 2905, a determination is made regarding whether there is more than one series in the dataset. If there is more than one series in the dataset, at 2910 a determination is made regarding whether there is more than one different value type in the dataset. If there is more than one different value type in the dataset, all series data with a particular value type are set to the primary y-axis (2925), and all series data with another value type is set to the secondary y-axis (2930).

If at 2910 it is determined that there is not more than one different value type in the dataset, at 2915 a determination is made regarding whether the range of the series with the largest range, divided by the median of the range, is greater than a predetermined number. According to one embodiment of the present invention, the predetermined number is four. If the answer is “yes,” at 2920 the series with the largest range is set to the secondary y-axis.

At 2935, a determination is made regarding whether there is another series. If there is another series, the series with the next-largest range is processed beginning at reference numeral 2915. If there are no more series, a primary y-axis is selected at 2940 and a secondary y-axis is selected ay 2945.

If at 2905 it is determined that there is only one series, at 2955 a determination is made regarding whether the order of the magnitude of the largest maximum for all series on the y-axis, minus the order of magnitude of the smallest minimum for all series on the y-axis, is greater than a predetermined number. If the answer is “yes,” at 2950 the y-axis is set to a logarithmic scale. If the answer at 2955 is “no,” at 2960 a determination is made regarding whether there is an unassigned secondary y-axis. If there is an unassigned secondary y-axis, a secondary y-axis is selected at 2945. If at 2960 there is no unassigned secondary y-axis, processing terminates.

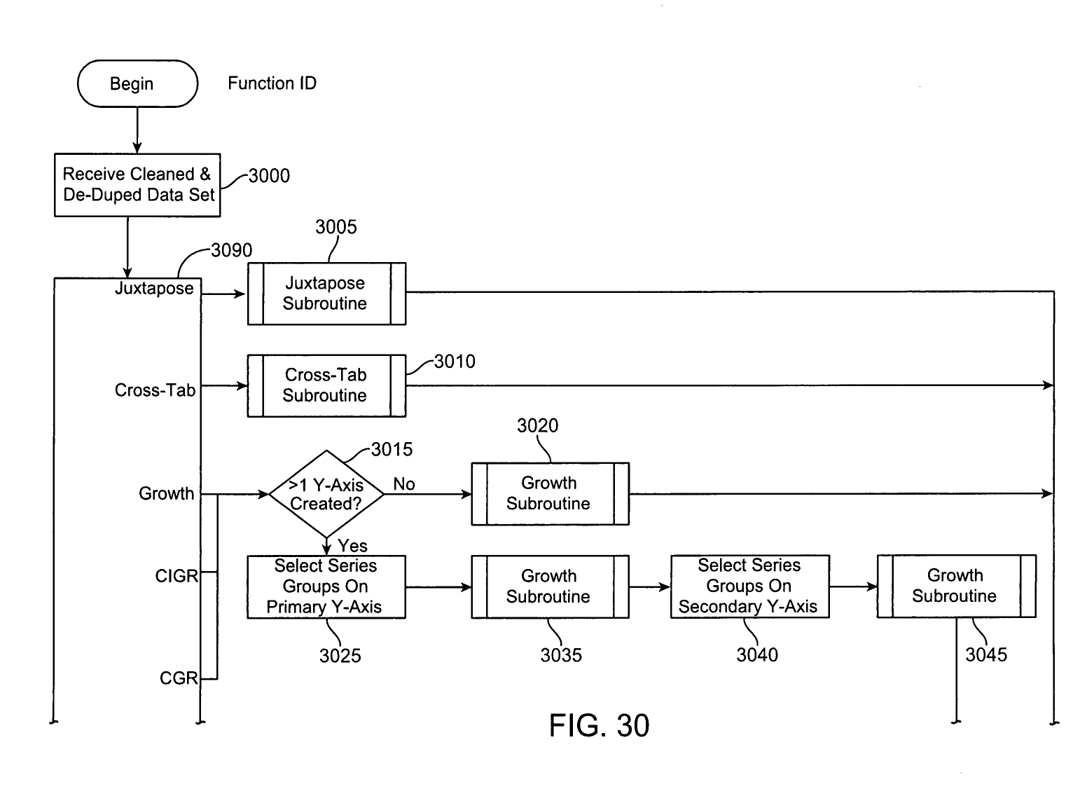

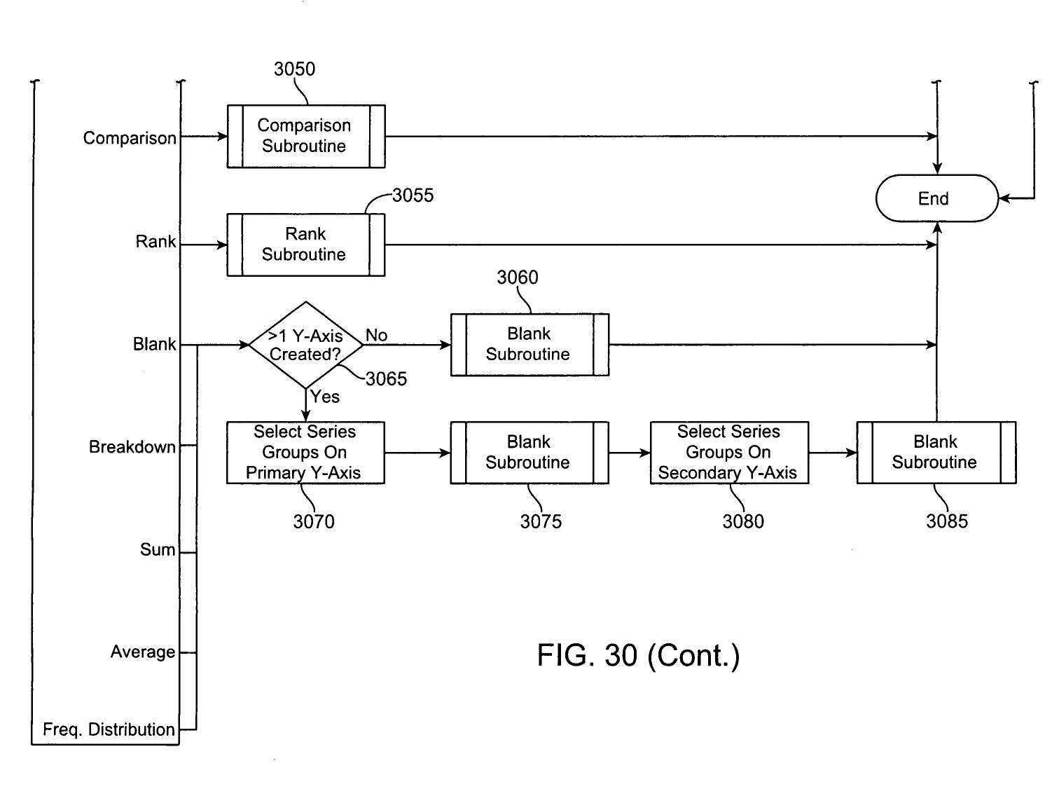

FIG. 30 is a flow diagram that illustrates a method for function identification in accordance with one embodiment of the present invention. FIG. 30 provides more detail for reference numerals 2830 and 2840 of FIG. 28. The processes illustrated in FIG. 30 may be implemented in hardware, software, firmware, or a combination thereof. At 3000, a cleaned and de-duped dataset is received. At 3090, a determination is made regarding which function has been executed. If the “juxtapose” function has been executed, it is processed at 3005. If a “cross-tab” function has been executed, it is processed at 3010. If a “CGR,” “CIGR,” or “Growth” function has been executed, at 3015, a determination is made regarding whether more than one y-axis has been created. If more than one y-axis has not been created, the function is processed at 3020. If at 3015 it is determined that more than one y-axis has been created, the series groups on the primary y-axis are selected at 3025, and the selected series groups are processed at 3035. At 3040, the series groups on the secondary y-axis are selected, and the selected series groups are processed at 3045.

If the Comparison function has been executed, it is processed at 3050. If the Rank function has been executed, it is processed at 3055. If the “Blank,” “Breakdown,” “Sum,” “Average,” or “Frequency Distribution” functions have been executed, at 3065, a determination is made regarding whether more than one y-axis has been created. If more than one y-axis has not been created, the “blank” function is processed at 3060. If at 3065 it is determined that more than one y-axis has been created, at 3070 the series groups on the primary y-axis are selected, and the selected series groups are processed at 3075. At 3080, the series groups on the secondary y-axis are selected. The selected series groups are processed at 3085.

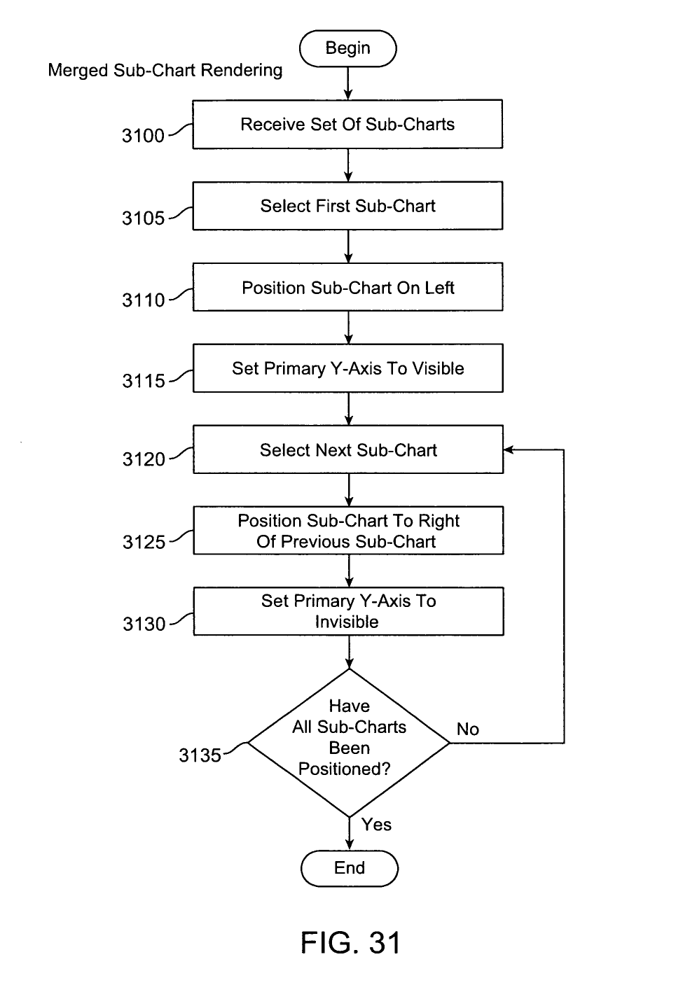

FIG. 31 is a flow diagram that illustrates a method for merged sub-chart rendering in accordance with one embodiment of the present invention. FIG. 31 provides more detail for reference numeral 2860 of FIG. 28. The processes illustrated in FIG. 31 may be implemented in hardware, software, firmware, or a combination thereof. At 3100, a set of sub-charts is received. At 3105, a first sub-chart is selected. At 3110, the first sub-chart is positioned on the left. At 3115, the primary y-axis is set to be visible. At 3120, a next sub-chart is selected. At 3125, the sub-chart selected at 3120 is positioned to the right of the previously selected sub-chart. At 3130, the primary y-axis is set to be invisible. At 3135, a determination is made regarding whether all sub-charts have been positioned. If at least one sub-chart has not been positioned, processing of the next sub-chart continues at 3120.

According to another embodiment of the present invention, the first sub-chart is positioned on the right at 3110, and at 3125, the sub-chart selected at 3120 is positioned to the left of the previously selected sub-chart.

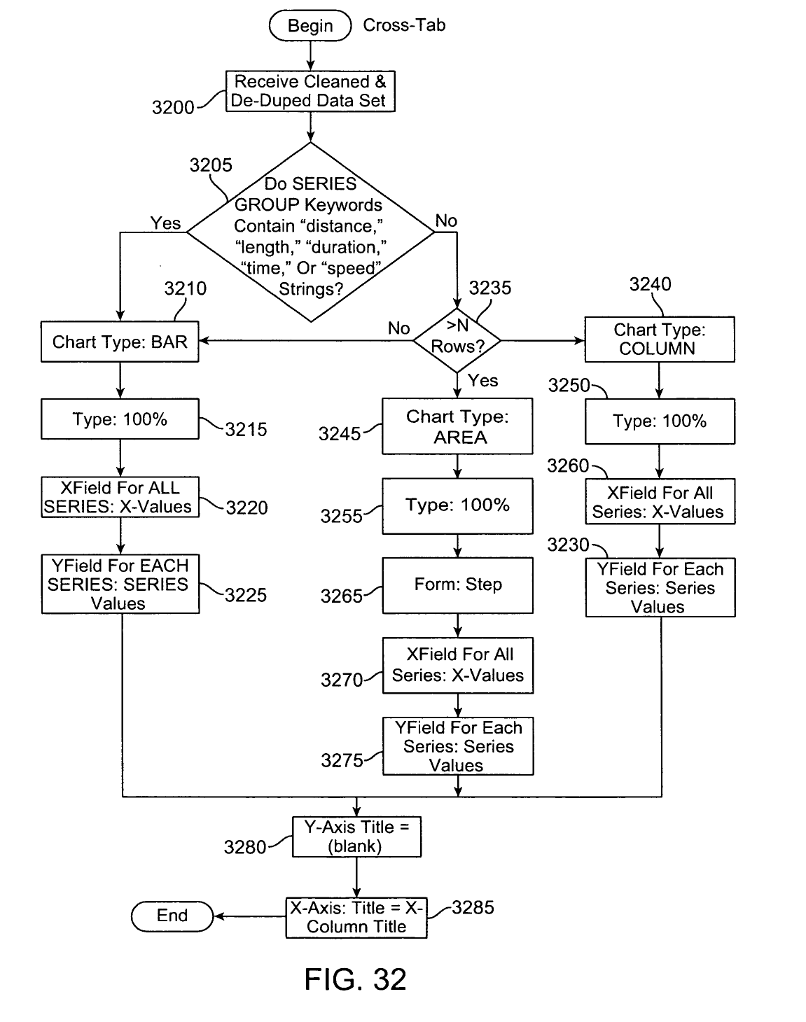

FIG. 32 is a flow diagram that illustrates a method for handling a “cross-tab” function in accordance with one embodiment of the present invention. FIG. 32 provides more detail for reference numeral 3010 of FIG. 30. The processes illustrated in FIG. 32 may be implemented in hardware, software, firmware, or a combination thereof. At 3200, a cleaned and de-duped dataset is received. At 3205, a determination is made regarding whether the SERIES GROUP keywords include any of the following character strings: “distance,” “length,” “duration,” “time,” “speed,” or the like. If the answer at 3205 is “yes,” at 3210 the chart type is set to “bar chart,” at 3215 the type is set to “100%,” at 3220 the xField for ALL SERIES is set to the x-values, and at 3225 the yField for EACH SERIES is set to the SERIES values.

If the answer at 3205 is “no,” at 3235 a determination is made regarding whether there are more than a first predetermined number of rows and more than a second predetermined number of rows. If there are less than the first predetermined number of rows but more than the second predetermined number of rows, the dataset is processed as a bar chart, beginning at reference numeral 3210. If there are more than the first predetermined number of rows, the dataset is processed as an AREA chart beginning at reference numeral 3245. If there are less than the second predetermined number of rows, the dataset is processed as a column chart beginning at reference numeral 3240.

At 3280, the y-axis title is set to blank. At 3285, the x-axis title is set to the column title.

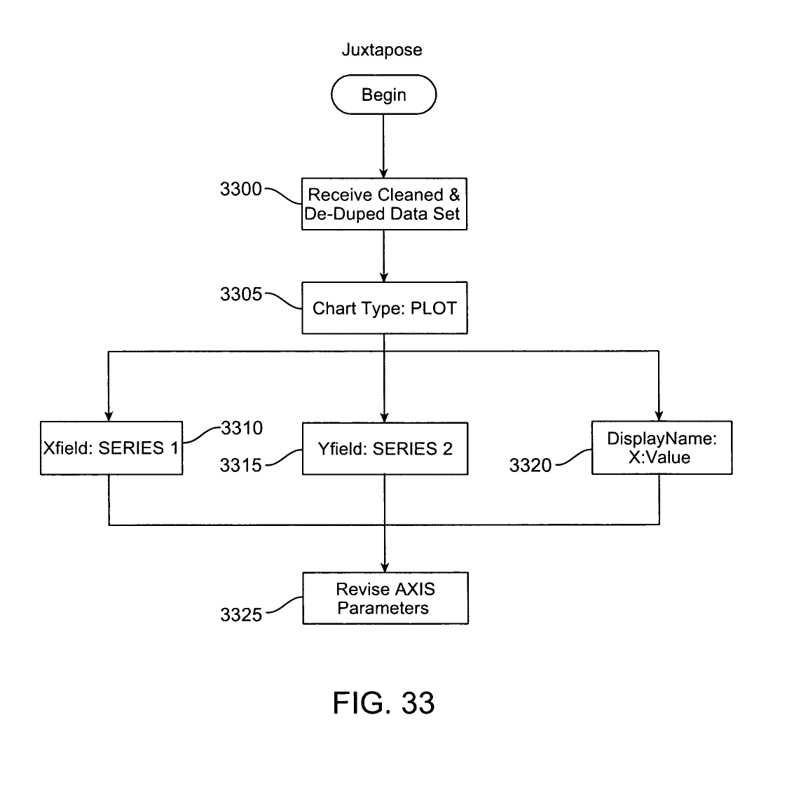

FIG. 33 is a flow diagram that illustrates a method for handling a “juxtapose” function in accordance with one embodiment of the present invention. FIG. 33 provides more detail for reference numeral 3005 of FIG. 30. The processes illustrated in FIG. 33 may be implemented in hardware, software, firmware, or a combination thereof. At 3300, a cleaned and de-duped dataset is received. At 3305, the chart type is set to PLOT. At 3310, the x-values are set to the first series (SERIES 1). At 3315, the y-values are set to the second series (SERIES 2). At 3320, the display name is set to the x value. At 3325, AXIS parameters are optionally revised.

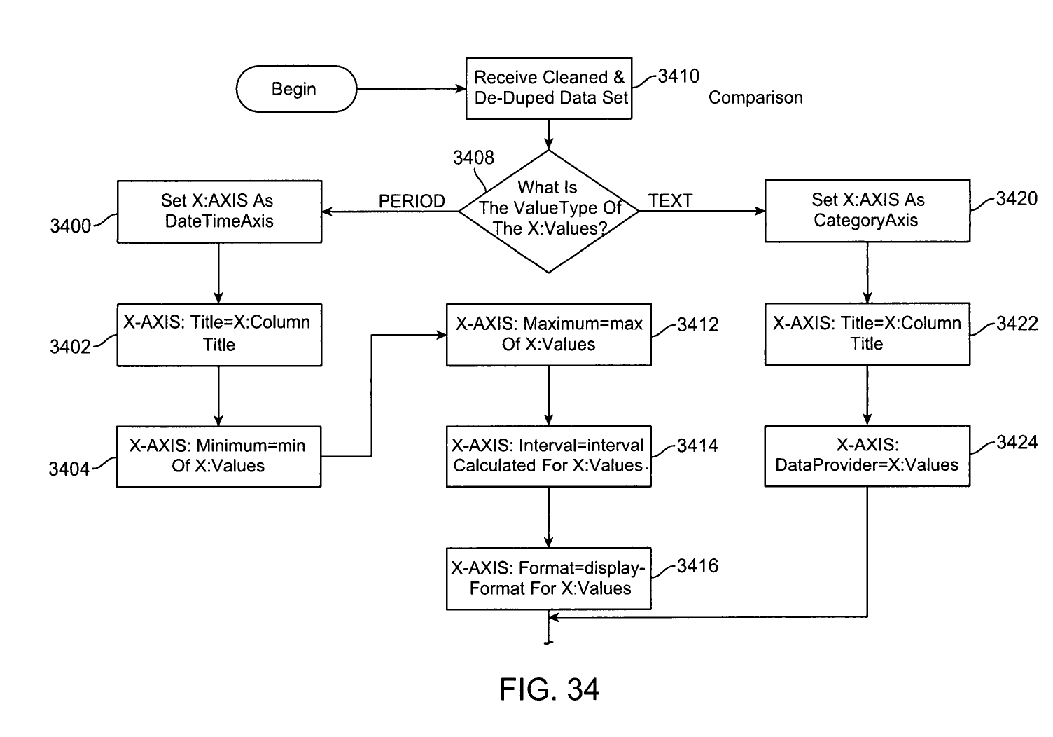

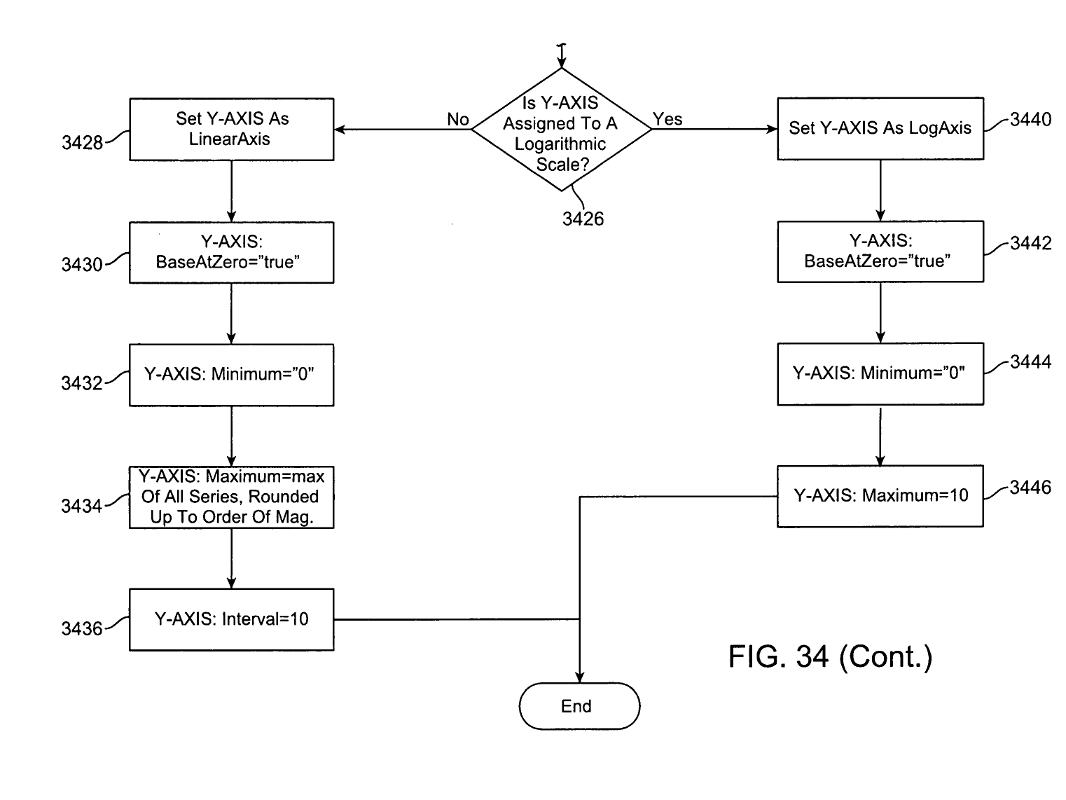

FIG. 34 is a flow diagram that illustrates a method for handling a comparison function in accordance with one embodiment of the present invention. FIG. 34 provides more detail for reference numeral 3050 of FIG. 30. The processes illustrated in FIG. 34 may be implemented in hardware, software, firmware, or a combination thereof. At 3410, a cleaned and de-duped dataset is received. At 3408, a determination is made regarding whether the x values are of type “PERIOD” or “TEXT.” If the x values are of type “TEXT,” the x-axis is set as the category axis at 3420, the title of the x-axis is set to the column title at 3422, and the data provider for the comparison is set to the x-values at 3424.

If the x values are of type “PERIOD,” the x-axis is set as the date-time axis at 3400, the title of the x-axis is set to the column title at 3402, the x-axis minimum is set to the minimum of the x values at 3404, the x-axis maximum is set to the maximum of the x values at 3412, the x-axis interval is set to the interval calculated for the x-values at 3414, and the x-axis display format is set to the display format for the x-values at 3416.

At 3426, a determination is made regarding whether the y-axis is assigned to a logarithmic scale. If the y-axis is assigned to a logarithmic scale, the y-axis is set as the linear axis at 3428, the base of the y-axis is set to 0 at 3430, the minimum value of the y-axis is set to 0 at 3432, the maximum value of the y-axis is set to the maximum of all series data rounded up to the order of magnitude at 3434, and the y-axis interval is set to 10 at 3436.

If at 3426 it is determined that the y-axis is not assigned to a logarithmic scale, the y-axis is set as the logarithmic axis at 3440, the base of the y-axis is set to 0 at 3442, the minimum value of the y-axis is set to, 0 at 3444, the maximum value of the y-axis is set to 10 at 3446.

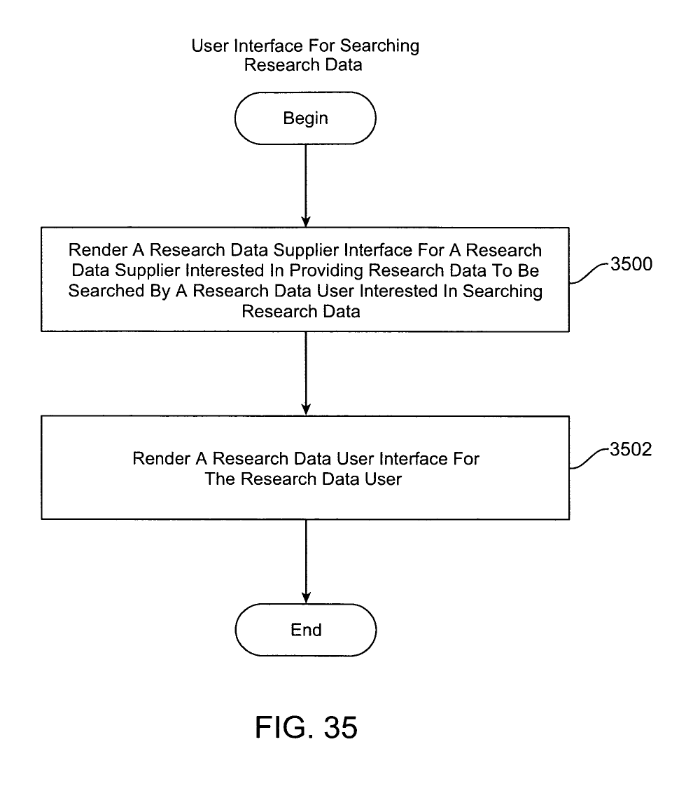

FIG. 35 is a flow diagram that illustrates a method for rendering research data search results in accordance with one embodiment of the present invention. The processes illustrated in FIG. 35 may be implemented in hardware, software, firmware, or a combination thereof. At 3500, a research data supplier interface is rendered for a research data supplier interested in providing research data to be searched by a research data user interested in searching research data. At 3502, a research data user interface for the research data user is rendered.

According to one embodiment of the present invention, a data supplier solutions interface provides information for use by a research data supplier. According to another embodiment of the present invention, a software developer solutions interface provides information for use by a software developer in providing research data to be searched by a research data user. According to another embodiment of the present invention, a developer interface provides information about the development of a system for searching research data. The developer interface is for use by developers of the system itself, to aid developers in development of the system—a sort of “in-house” informational resource.

According to another embodiment of the present invention, the research data user interface includes a search results interface for displaying a list of reports that match search criteria of the research data user. According to another embodiment of the present invention, the research data user interface includes a report preview interface for previewing a particular report in a list of reports, where the particular report is selected by the research data user. According to another embodiment of the present invention, the research data user interface includes a shopping cart interface for listing reports that the research data user has selected for purchase. According to another embodiment of the present invention, the research data user interface includes a sign-in interface for authenticating the research data user prior to the research data user purchasing one or more research data report. According to another embodiment of the present invention, the research data user interface includes a billing information interface for receiving billing information from the research data user. According to another embodiment of the present invention, the research data user interface includes confirmation interface for presenting a summary of an order of the research data user prior to the research data user placing an order. According to another embodiment of the present invention, the research data user interface includes a library interface for presenting reports purchased by the research data user, receiving one or more profile edits from the research data user, and presenting a list of previous orders made by the research data user.

While embodiments and applications of this invention have been shown and described, it would be apparent to those skilled in the art having the benefit of this disclosure that many more modifications than mentioned above are possible without departing from the inventive concepts herein. The invention, therefore, is not to be restricted except in the spirit of the appended claims.

What is claimed is:

1. A method comprising:
presenting a research data supplier interface for a research data supplier interested in providing research data to be searched by a research data user interested in searching research data; and
presenting a research data user interface for the research data user.

2. The method of claim 1, further comprising presenting a business solutions interface, the business solutions interface comprising:
a data supplier solutions interface for use by the research data supplier; and
a software developer solutions interface for use by software developers in providing research data to be searched by the research data user.

3. The method of claim 1, further comprising presenting a developer interface for providing information about the development of a system for searching research data.

4. The method of claim 1 wherein the research data user interface further comprises a search results interface for displaying a list of reports that match search criteria of the research data user.

5. The method of claim 1 wherein the research data user interface further comprises a report preview interface for previewing a particular report in the list of reports, the particular report selected by the research data user.

6. The method of claim 1 wherein the research data user interface further comprises a shopping cart interface for listing reports that the research data user has selected for purchase.

7. The method of claim 1 wherein the research data user interface further comprises a sign-in interface for authenticating the research data user prior to the research data user purchasing one or more research data report.

8. The method of claim 1 wherein the research data user interface further comprises a billing information interface for receiving billing information from the research data user.

9. The method of claim 1 wherein the research data user interface further comprises a confirmation interface for presenting a summary of an order of the research data user prior to the research data user placing the order.

10. The method of claim 1 wherein the research data user interface further comprises a library interface for:
presenting reports purchased by the research data user;
receiving profile edits from the research data user; and
presenting a list of previous orders made by the research data user.

11. An apparatus comprising:
a memory; and
a processor configured to:
present a research data supplier interface for a research data supplier interested in providing research data to be searched by a research data user interested in searching research data; and
present a research data user interface for the research data user.

12. The apparatus of claim 11, further comprising presenting a business solutions interface, the business solutions interface comprising:
a data supplier solutions interface for use by the research data supplier; and
a software developer solutions interface for use by software developers in providing research data to be searched by the research data user.

13. The apparatus of claim 11 wherein the processor is further configured to present a developer interface for providing information about the development of a system for searching research data.

14. The apparatus of claim 11 wherein the research data user interface further comprises a search results interface for displaying a list of reports that match search criteria of the research data user.

15. The apparatus of claim 11 wherein the research data user interface further comprises a report preview interface for previewing a particular report in the list of reports, the particular report selected by the research data user.

16. The apparatus of claim 11 wherein the research data user interface further comprises a shopping cart interface for listing reports that the research data user has selected for purchase.

17. The apparatus of claim 11 wherein the research data user interface further comprises a sign-in interface for authenticating the research data user prior to the research data user purchasing one or more research data report.

18. The apparatus of claim 11 wherein the research data user interface further comprises a billing information interface for receiving billing information from the research data user.

19. The apparatus of claim 11 wherein the research data user interface further comprises a confirmation interface for presenting a summary of an order of the research data user prior to the research data user placing the order.

20. The apparatus of claim 11 wherein the research data user interface further comprises a library interface for:
presenting reports purchased by the research data user;
receiving profile edits from the research data user; and
presenting a list of previous orders made by the research data user.

21. A program storage device readable by a machine, embodying a program of instructions executable by the machine to perform a method, the method comprising:
presenting a research data supplier interface for a research data supplier interested in providing research data to be searched by a research data user interested in searching research data; and
presenting a research data user interface for the research data user.

22. An apparatus comprising:
means for presenting a research data supplier interface for a research data supplier interested in providing research data to be searched by a research data user interested in searching research data; and
means for presenting a research data user interface for the research data user.
